(19) United States
(12) Patent Application Publication
(10) Pub. No.: US 2026/0234761 A1
(43) Pub. Date: Aug. 13, 2026

(54) TUNGSTEN ALLOY WIRE, PREPARATION METHOD THEREFOR AND USE THEREOF, AND TUNGSTEN CARBIDE ALLOY FILAMENT

(71) Applicant: XIAMEN HONGLU TUNGSTEN MOLYBDENUM INDUSTRY CO., LTD., Xiamen, Fujian (CN)

(72) Inventors: Yijin FANG, Xiamen, Fujian (CN); Donghong GUO, Xiamen, Fujian (CN); Xiangcao JIANG, Xiamen, Fujian (CN); Minfeng TANG, Xiamen, Fujian (CN); Zongxing WEI, Xiamen, Fujian (CN); Xiaojun JIANG, Xiamen, Fujian (CN); Guoqin ZHANG, Xiamen, Fujian (CN); Liangmu LIU, Xiamen, Fujian (CN); Hui ZHAO, Xiamen, Fujian (CN)

(73) Assignee: XIAMEN HONGLU TUNGSTEN MOLYBDENUM INDUSTRY CO., LTD., Xiamen, Fujian (CN)

(21) Appl. No.: 19/470,784

(22) PCT Filed: Aug. 13, 2024
(86) PCT No.: PCT/CN2024/111592

§ 371 Date: Sep. 29, 2025

(30) Foreign Application Priority Data
Oct. 25, 2023 (CN) 202311393420.6

(51) Int. Cl. C22C 32/00; B22F 1/12; B22F 3/16; B22F 3/24; B22F 5/12; H01J 9/02; H01J 23/05

(52) U.S. Cl. CPC C22C 32/0031; B22F 1/12; B22F 3/162; B22F 3/24; B22F 5/12; H01J 9/022; H01J 23/05; B22F 2003/248; B22F 2203/11; B22F 2301/20; H01J 2223/05

(57) ABSTRACT

A tungsten alloy wire, a preparation method therefor and a use thereof, and a tungsten carbide alloy filament. The tungsten alloy wire comprises the following components: 0.0005-0.3 wt % of a carbon element, 0.25-2.6 wt % of an M element, 0.05-0.5 wt % of an oxygen element and the balance being a tungsten element and inevitable impurities, and does not comprise a thorium element; and the initial recrystallization temperature of the tungsten alloy wire ranges from 48% Fc to 56% Fc, and/or the average size of 80% Fc recrystallization grains is 1-15 um. The tungsten alloy wire does not comprise the thorium element, does not cause radioactive contamination, has the initial recrystallization temperature ranging from 48% Fc to 56% Fc, and has the processing performance greatly improved compared with that of a thorium-containing tungsten wire; compared with a thorium-containing tungsten wire, the tungsten alloy wire has less flaw detection crack points, when the tungsten alloy wire is used as a substrate of a tungsten carbide alloy filament, grains of the carbonized substrate are fine, the filament is not easy to break in the production and use of a magnetron coil, and the production yield and quality are improved.

### TECHNICAL FIELD

The present invention relates to the technical field of filament cathode materials, and in particular to a tungsten alloy wire and a preparation method therefor and use thereof, and a tungsten carbide alloy filament.

### BACKGROUND

The filament cathode is the electron emitter and is widely used in the field of microwave oven magnetrons. The performance of the filament cathode has a great influence on the working characteristics and life of the magnetron and is regarded as the heart of the magnetron. Existing filament materials are mainly made of tungsten-thorium oxide materials or tungsten-rare earth oxides, examples for which are as follows:

The Chinese invention patent with application number CN201010299139 and publication date Apr. 3, 2013, disclosed a method for doping powder for magnetron coils. The process of the invention includes steps such as doping, stirring, and steam drying. It is wherein a neutralizing additive ammonia NH₃·H₂O solution is added to the thorium nitrate solution, and the prepared mixed solution is evenly sprayed onto the surface of the blue tungsten WO2.9 placed in the doping pot and stirred. The doping pot is evacuated and heated with water, while stirring while heating. In a vacuum state, the powder is dried by steam heating, and finally a doped tungsten-thorium oxide powder with uniform doping and low impurity content is obtained.

In this invention patent application (application number CN201010299139), when thorium oxide is added to pure tungsten for the magnetron coil material, and the service life of the magnetron coil material can reach more than 1000 hours of continuous operation. However, the cathode product made of this composite material has a high brittle-ductile transition temperature and is difficult to process and form, which can easily lead to the magnetron cathode breaking during production and transportation. In addition, the recrystallization temperature is low, and the magnetron coil will undergo abnormal recrystallization growth during the carbonization process, and often break during use and transportation, causing the magnetron to fail. At the same time, since thorium is a radioactive element, using thorium as the main added raw material will cause pollution to the environment during smelting, production, transportation and usage, and the final products made from thorium will also have potential adverse effects on the health of those exposed to them.

In summary, the traditional tungsten-thorium filament is radioactive, which will cause pollution to the environment, and the final products will also have potential adverse effects on the health of those exposed to them. In addition, the existing tungsten-thorium filament has a low recrystallization temperature, many cracks in the wire, and the magnetron coil will grow abnormally during the carbonization process, which often causes it to break during production, use and transportation, resulting in low product yield and poor quality. How to solve the above problems is the difficulty that technicians in this field are committed to overcoming.

### SUMMARY OF THE INVENTION

In order to solve the problems existing in the above-mentioned prior art: the traditional tungsten-thorium filament is radioactive, which will cause pollution to the environment, and the final products will also have potential adverse effects on the health of those exposed to them. In addition, the tungsten base body of the existing thorium tungsten filament after carburization is a fully recrystallized structure with coarse grains, which will cause the filament to break easily during the production and use of the magnetron. In addition, the thorium-containing tungsten material also has the problems of poor processing performance and many wire defects. The present invention provides a tungsten alloy filament and a preparation method, and the specific technical solution is as follows:

The present invention provides a method for preparing tungsten alloy wire, and its technical solution is as follows:
the tungsten alloy comprises the following components: 0.0005 wt % to 0.3 wt % of a carbon element, 0.25 wt % to 2.6 wt % of an M element, 0.05 wt % to 0.5 wt % of an oxygen element, the balance being a tungsten element and inevitable impurities, and does not comprise a thorium element; the M element is selected from the group consisting of La, Y, Sc, Nd, Sm, Lu, Ce, Gd, Tb, Dy, Ho, Pr, Er, Tm, Yb, Eu, Hf, and Zr, or a combination of any two or more thereof;
a preparation process of the tungsten alloy wire comprises a doping for powder production step, a powder pressing step, a sintering step, and a pressure processing step in sequence; in the pressure processing step, the tungsten alloy sintered billet obtained after sintering is refined into an intermediate specification wire with a diameter of 1.5 mm to 3.5 mm; then the intermediate specification wire is subjected to an oxidation annealing at 1200° C. to 1500° C., and the annealing speed is 3 m/min to 10 m/min; after oxidation annealing, the intermediate specification wire is further processed to the required wire diameter specification, so as to obtain tungsten alloy wire;
wherein the initial recrystallization temperature of the tungsten alloy wire is in a range from 48% Fc to 56% Fc, and/or the average size of 80% Fc recrystallized grains is in a range from 1 μm to 15 μm.

In one embodiment, the sintering step adopts a high-temperature sintering method to obtain a tungsten alloy sintered billet; the heating curve of the high-temperature sintering is as follows: heating heating from room temperature to A1 at a certain rate, and keeping warm at A1 for a certain period of time; heating from A1 to A2, wherein the heating time is H3; keeping warm at A2 for H4 hours; wherein A1 is 950° C. to 1250° C., H3 is 1.5 hour to 2.5 hours, A2 is 1300° C. to 1500° C., and H4 is 2.5 hours to 4.5 hours; heating from A2 to A3 at a certain rate, wherein A3 is 1700° C. to 1900° C.; keeping warm at A3 for a certain period of time; heating from A3 to A4 at a certain rate, wherein A4 is 2050° C. to 2250° C.; keeping warm at A4 for a certain period of time; and the tungsten alloy sintered billet is obtained by natural cooling from A4.

In one embodiment, the heating curve of the high-temperature sintering is as follows: heating from room temperature to A1, with the heating time H1 ranging from 5 hours to 8 hours, and A1 ranging from 950° C. to 1250° C.; keeping warm at A1 for H2 hours, with H2 ranging from 1 hour to 3 hours; heating from A1 to A2, with the heating time H3 ranging from 1.5 hours to 2.5 hours, and A2 ranging from 1300° C. to 1500° C.; keeping warm at A2 for H4 hours, with H4 ranging from 2.5 hours to 4.5 hours; heating from A2 to A3, with the heating time H5 ranging from 1 hour to 3 hours, and A3 ranging from 1700° C. to 1900° C.; keeping warm at A3 for H6 hours, with H6 ranging from 1 hour to 3 hours; heating from A3 to A4, with the heating time H7 ranging from 1 hour to 3 hours, and A4 ranging from 2050° C. to 2250° C.; keeping warm at A4 for H8 hours, with H8 ranging from 5 hours to 10 hours; and cooling naturally from A4 to obtain the tungsten alloy sintered billet.

In one embodiment, the M element is in the form of an oxide, and the average size of the oxide particles in the tungsten alloy wire is in a range from 100 nm to 500 nm.

In some embodiments, the density of the sintered tungsten alloy billet is 17.5 g/cm³ to 18.3 g/cm³; and the average size of the oxide particles of the sintered tungsten alloy billet is less than 2.0 μm.

The present invention provides a tungsten alloy wire, which comprises the following components: 0.0005 wt % to 0.3 wt % of a carbon element, 0.25 wt % to 2.6 wt % of am M element, 0.05 wt % to 0.5 wt % of an oxygen element, the balance being a tungsten element and inevitable impurities, and does not contain a thorium element; wherein, the M element is selected from the group consisting of La, Y, Sc, Nd, Sm, Lu, Ce, Gd, Tb, Dy, Ho, Pr, Er, Tm, Yb, Eu, Hf, and Zr, or a combination of any two or more thereof; the initial recrystallization temperature of the tungsten alloy wire is in a range from 48% Fc to 56% Fc, and/or the average size of the 80% Fc recrystallized grains is in a range from 1 μm to 15 μm.

In some embodiments, the M element is in the form of oxide, and the average size of the oxide particles in the tungsten alloy wire is in a range from 100 nm to 500 nm.

In one embodiment, the M element is in the form of an oxide, and the carbon element is in the form of a carbide or a carbon simple substance; the oxide of M is selected from the group consisting of lanthanum oxide, yttrium oxide, scandium oxide, neodymium oxide, samarium oxide, lutetium oxide, cerium oxide, gadolinium oxide, terbium oxide, dysprosium oxide, holmium oxide, praseodymium oxide, erbium oxide, hafnium oxide, and zirconium oxide; the carbide is selected from the group consisting of lanthanum carbide, zirconium carbide, yttrium carbide, hafnium carbide and tungsten carbide, or a combination of any two or more thereof.

In one embodiment, the tungsten alloy wire has a wire diameter of 800 μm or less, and a number of crack points detected by flaw detection less than 5/100 meters.

In one embodiment, the component of the tungsten alloy wire further comprises T element; the T element is a metal element, and the T is selected from at least one of K, Re, Mo, Fe, and Co; wherein the mass content of the Re is less than 1000 ppm.

The present invention further provides use of tungsten alloy wire as described above, wherein the tungsten alloy wire, after being subjected to carbonizing treatment, is used as a cathode alloy wire for a microwave heating device.

The present invention further provides a tungsten carbide alloy filament, which is obtained by subjecting the above-mentioned tungsten alloy wire to carbonizing treatment.

### Based on the Above, Compared with the Prior Art, the Present Invention has the Following Advantages

The tungsten alloy wire of the present invention does not comprise the thorium element, does not cause radioactive contamination.

The tungsten alloy wire of the present invention has the initial recrystallization temperature ranging from 48% Fc to 56% Fc, and has the processing performance greatly improved compared with that of a thorium-containing tungsten wire; compared with a thorium-containing tungsten wire, the tungsten alloy wire has less flaw detection crack points, when the tungsten alloy wire is used as a base body of a tungsten carbide alloy filament, grains of the carbonized base body are fine, the filament is not easy to break in the production and use of a magnetron coil, and the production yield and quality are improved.

Other features and beneficial effects of the present invention will be described in the following description, and partly become apparent from the description, or understood by practicing the present invention. The object and other beneficial effects of the present invention can be realized and obtained by the structures particularly pointed out in the description, claims and drawings.

### BRIEF DESCRIPTION OF THE DRAWINGS

In order to more clearly describe specific implementations of the present application or technical solutions in the prior art, the accompanying drawings needed by the description in the specific implementations or in the prior art will be briefly introduced below. Apparently, the accompanying drawings in the following description are some implementations of the present application. Those ordinarily skilled in the art may also obtain other accompanying drawings according to these accompanying drawings without making creative work.

FIG. 1 is a schematic diagram of a partial structure of a carburized tungsten alloy filament provided by the present invention;

FIG. 2 is a schematic structural diagram of a cross section of a carburized tungsten alloy filament provided by the present invention;

FIG. 3 is a schematic structural diagram of a longitudinal section of a carburized tungsten alloy filament provided by the present invention;

FIG. 4 is an enlarged view of point A in FIG. 2;

FIG. 5 is a partial structural schematic diagram of a cross section of a carburized tungsten alloy filament provided by the present invention;

FIG. 6 is a metallographic image of Comparative Example 1 provided by the present invention at 44% FC;

FIG. 7 is a metallographic image of Comparative Example 1 provided by the present invention at 46% FC;

FIG. 8 is a metallographic image of Comparative Example 1 provided by the present invention at 48% FC;

FIG. 9 is a metallographic image of Comparative Example 1 provided by the present invention at 50% FC;

FIG. 10 is a metallographic image of Example 1 provided by the present invention at 48% FC;

FIG. 11 is a metallographic image of Example 1 provided by the present invention at 50% FC;

FIG. 12 is a metallographic image of Example 1 provided by the present invention at 52% FC;

FIG. 13 is a schematic diagram of the crystal structure of Comparative Example 1 provided by the present invention;

FIG. 14 is a schematic diagram of the crystal structure of Example 1 provided by the present invention;

FIG. 15 is a diagram showing the channel distribution of the cross section of Example 1 provided by the present invention;

FIG. 16 is a diagram showing the channel distribution in the longitudinal section of Example 1 provided by the present invention;

FIG. 17 is a diagram showing the channel distribution of the cross section of Comparative Example 1 provided by the present invention;

FIG. 18 is a schematic diagram of a process flow for preparing a heating device from a tungsten alloy wire provided by the present invention;

FIG. 19 is a graph showing the conversion relationship between FC % and degrees Celsius;

FIG. 20 is a schematic diagram showing the principle of the high-temperature sintering process.

Reference number: 100 base body, 200 carburized layer, 210 channel, 220 outer edge of filament, 211 first channel, 212 second channel.

### DETAILED DESCRIPTION

In order to make the object, technical solutions and advantages of the examples of the present invention clearer, the technical solutions in the examples of the present invention will be clearly and completely described below in conjunction with the drawings in the examples of the present invention. Obviously, the described examples are part of the examples of the present invention, rather than all the examples; the technical features designed in different implementation modes of the present invention described below can be combined with each other as long as they do not conflict with each other; based on the examples of the present invention, all other embodiments obtained by those skilled in the art without making creative work are within the scope of protection of the present invention.

In the description of the present invention, it should be noted that all terms used in the present invention (including technical terms and scientific terms) have the same meanings as those generally understood by those skilled in the art to which the present invention belongs, and cannot be understood as limiting the present invention; it should be further understood that the terms used in the present invention should be understood to have the same meanings as these terms in the context of this specification and in the relevant fields, and should not be understood in an idealized or overly formal sense, unless explicitly defined in the present invention.

### The Present Invention Provides a Tungsten Alloy Wire, and the Technical Solution is as Follows:

the tungsten alloy comprises the following components: 0.0005 wt % to 0.3 wt % of a carbon element, 0.25 wt % to 2.6 wt % of an M element, 0.05 wt % to 0.5 wt % of an oxygen element, the balance being a tungsten element and inevitable impurities, and does not comprise a thorium element; the M element is selected from the group consisting of La, Y, Sc, Nd, Sm, Lu, Ce, Gd, Tb, Dy, Ho, Pr, Er, Tm, Yb, Eu, Hf, and Zr, or a combination of any two or more thereof; the M element is in the form of an oxide, and the carbon element is in the form of a carbide or a carbon simple substance;

The initial recrystallization temperature of the tungsten alloy wire is in a range from 48% Fc to 56% Fc, and/or the average size of the 80% Fc recrystallized grains is in a range from 1 μm to 15 μm.

### For Component Composition:

In the present invention, one or more oxides of M and carbon elements are added. Since the oxides of M and carbides in the tungsten base body react at high temperatures (the working temperature of the tungsten carbide alloy filament is a high temperature condition), for example, lanthanum oxide reacts with tungsten carbide to generate lanthanum atoms, and the size of the generated lanthanum atoms is much smaller than that of lanthanum oxide particles. In this way, the migration and diffusion speed of lanthanum atoms in the tungsten base body will be very fast, thereby improving the diffusion speed of M metal atoms.

In summary, compared with thoriated tungsten filaments, the present invention uses M oxide combined with carbon element (carbide or carbon simple substance), which can achieve the same or even higher electron emission capability as thoriated tungsten at a lower operating voltage (excitation temperature), and it is easier to ensure the balance between the loss and migration of rare earth atoms in the carburized layer of the filament, thereby ensuring the stability of the filament electron emission.

### For the Characteristics of the Initial Recrystallization Temperature:

The initial recrystallization temperature of the tungsten alloy wire provided by the present invention is higher than that of the thoriated tungsten wire, which is 48% Fc to 56% Fc in the present application, while the thoriated tungsten wire is around 46% FC (2020° C.).

The average size of 80% Fc recrystallized grains of the tungsten alloy wire provided by the present invention is finer than that of the thoriated tungsten wire. The average size of 80% Fc recrystallized grains of the tungsten alloy wire provided by the present application is in a range from 1 μm to 15 μm, and the average size of 80% Fc recrystallized grains of the thoriated tungsten filament is in a range from 16 μm to 150 μm.

The above characteristics of high initial recrystallization temperature and small average size of 80% Fc recrystallized grains make the tungsten base body structure of the filament produced by the tungsten alloy wire of the present invention finer than that of the thorium tungsten filament after carburization in the magnetron.

There is a carbonization process in the process of preparing tungsten alloy wire into carburized layer filament. The carbonization temperature is in a range from 2000° C. to 2500° C. The original thoriated tungsten filament is carbonized at this temperature (the reason is that its initial recrystallization temperature is too low after analysis). The grain structure will show recrystallization phenomenon, and the grains are coarse, which makes the filament brittle and poor in seismic resistance after carbonization. It is very easy to break the wire during the assembly, production, transportation and subsequent use of the magnetron microwave oven. Compared with the thoriated tungsten filament, the initial recrystallization temperature of the filament material produced in the present invention is higher than that of the original thoriated tungsten filament, and the average size of 80% Fc recrystallized grains is smaller than that of the original thoriated tungsten filament. After the tungsten alloy wire of the present application is carbonized, the filament structure is still fine-grained, and the brittleness is less than that of the traditional thoriated tungsten filament material. The tungsten alloy filament with fine grain structure has better seismic resistance than the thoriated tungsten filament. The filament breaking rate of the magnetron produced by the present application is much lower than that of the magnetron produced by traditional thoriated tungsten.

Optionally, the initial recrystallization temperature of the tungsten alloy wire may be 48% FC to 52% FC, such as 48% FC, 50% FC, 52% FC, and so on.

Optionally, the average size of 80% Fc recrystallized grains of the tungsten alloy wire can be 1 μm to 8 μm, 8 μm to 12 μm, 12 μm to 15 μm, and so on, such as 4.0 μm, 8.5 μm, 13 μm, and so on.

For the Average Size Characteristics of the Oxide Particles in the Tungsten Alloy Wire: The Average Size of the Oxide Particles in the Tungsten Alloy Wire is in a Range from 100 Nm to 500 nm.

The average size of the oxide particles of the tungsten alloy wire of the present application is in a range from 100 nm to 500 nm.

The reason why the oxide particle size of the tungsten alloy wire of the present application is controlled within the specified range of the present application is that the size of the oxide particles of the tungsten alloy wire determines the size of the oxide particles of the filament after carburization. If the oxide particles of the wire are too coarse relative to the range specified in the present application, then during the use of the magnetron, it will be more difficult for the oxide particles of M to migrate to the surface of the filament, which will make it easier for the balance of rare earth element loss and replenishment on the surface of the filament to be broken, and the electron emission of the magnetron will be more unstable.

Optionally, the average size of the oxide particles may also be 100 nm to 300 nm, 300 nm to 500 nm, and so on, such as 200 nm, 300 nm, 450 nm, and so on.

### The Present Invention Also Provides a Preferred Embodiment of a Method for Preparing Tungsten Alloy Wire to Achieve the Above-Mentioned Recrystallization Temperature Range and Average Size Range Parameters of Oxide Particles:

It comprises the following steps:
Step 1: doping and powder making: sequentially performing the doping process, the reduction process and the powder making process to obtain a finished powder raw material; wherein the doping process is solid-liquid doping or solid-solid doping;
Step 2: powder pressing: using isostatic pressing to press the finished powder raw material into a compact, and pre-sintering the compact at a low temperature in a hydrogen atmosphere, increasing the compact strength; wherein the powders are pressed into compacts with a unit weight of 1.5 kg to 5.0 kg at a pressure of 160 MPa to 240 MPa;
Step 3: high-temperature sintering: adopt high-temperature sintering or vertical melting sintering to obtain a sintered billet with a density of 17.5 g/cm³ to 18.3 g/cm³, that is, to obtain the billet-shaped tungsten alloy material;

The heating curve of the high-temperature sintering is as follows:
heating from room temperature to A1, with the heating time H1 ranging from 5 hours to 8 hours, and A1 ranging from 950° C. to 1250° C.;
for example, H1 is 5 hours to 7 hours, 7 hours to 8 hours, and so on, and another example is 6 hours, 7.5 hours, and so on; A1 is 950° C. to 1050° C., 1050° C. to 1250° C., and so on, and another example is 1000° C., 1100° C., and so on;
keeping warm at A1 for H2 hours, with H2 ranging from 1 hour to 3 hours;
for example, H2 is 1 hour to 2 hours, 2 hours to 3 hours, and so on, and another example is 1.5 hours, 2.5 hours, and so on;
heating from A1 to A2, with the heating time H3 ranging from 1.5 hours to 2.5 hours, A2 ranging from 1300° C. to 1500° C.;
for example, H3 is 1.5 hours to 2.0 hours, 2.0 hours to 2.5 hours, and so on, and another example is 1.5 hours, 2.0 hours, 2.4 hours, and so on; A2 is 1300° C. to 1400° C., 1400° C. to 1500° C., and so on, and another example is 1350° C., 1500° C., and so on;
keeping warm at A2 for H4 hours, with H4 ranging from 2.5 hours to 4.5 hours;
for example, H4 is 2.5 hours to 3.0 hours, 3.0 hours to 4.0 hours, and so on, and another example is 2.8 hours, 3.5 hours, and so on;
heating from A2 to A3, with the heating time H5 ranging from 1 hour to 3 hours, and A3 ranging from 1700° C. to 1900° C.;
for example, H5 is 1 hour to 2 hours, 2 hours to 3 hours, and so on, and another example is 1.6 hours, 2.0 hours, 2.5 hours, and so on; A3 is 1700° C. to 1800° C., 1800° C. to 1900° C., and so on, and another example is 1750° C., 1850° C., and so on;
keeping warm at A3 for H6 hours ranging from 1 hour to 3 hours;
for example, H6 is 1 hour to 2 hours, 2 hours to 3 hours, and so on, and another example is 1.5 hours, 2.5 hours, and so on;
heating from A3 to A4, with heating time H7 ranging from 1 hour to 3 hours, and A4 ranging from 2050° C. to 2250° C.;
for example, H7 is 1 hour to 2 hours, 2 hours to 3 hours, and so on, and another example is 1.5 hours, 2.5 hours, and so on; A4 is 2050° C. to 2150° C., 2150° C. to 2250° C., and so on, and another example is 2100° C., 2200° C., and so on;
keeping warm at A4 for H8 hours ranging from 5 hours to 10 hours;
for example, H8 is 5 hours to 7 hours, 7 hours to 10 hours, and so on, and another example is 6 hours, 8 hours, and so on;
cooling naturally from A4 to obtain sintered billets;
Step 4: pressure processing:
4.1 in the pressure processing step, the tungsten alloy sintered billet obtained after sintering is refined into an intermediate specification wire with a diameter of 1.5 mm to 3.5 mm;
4.2 then, the intermediate specification wire is subjected to oxidation annealing at 1200° C. to 1500° C., and the annealing speed is 3 m/min to 10 m/min; for example, the annealing speed is 3 m/min to 7 m/min, 7 m/min to 10 m/min, and so on, and for example, 3 m/min, 5 m/min, 7 m/min, and so on; the oxidation annealing is 1200° C. to 1350° C., 1350° C. to 1500° C., and so on, and for example, 1250° C., 1400° C., and so on;
4.3 After oxidation annealing, the intermediate specification wire is continued to be processed to the required wire diameter specification to obtain tungsten alloy wire (also known as black wire); wherein multiple passes of rotary forging and drawing are used for fine diameter processing; the oxidation annealing process is carried out in the oxidation annealing equipment, and the annealing speed refers to the speed of the wire passing through the annealing tank, which means the length of the wire passing through the annealing tank per unit time.
Step 5: white wire cleaning: electrolytic cleaning is used to clean the tungsten alloy wire into tungsten alloy white wire that can be processed into microwave oven heating device filament;
Step 6: winding: the white wire is wound into a spring-shaped filament structure for heating devices to obtain tungsten alloy wire.

### Important Control Points for the Preferred Embodiment of the Preparation Method:

### (1) Oxidation Annealing Treatment of Intermediate Specification Products:

The present application provides a specific treatment method for oxidation annealing in the above-mentioned pressure processing step, so that the initial recrystallization temperature of the tungsten alloy is controlled within the above-mentioned required range (48% Fc to 56% Fc): a stress relief oxidation annealing at a temperature of 1200° C. to 1500° C. is added at the middle specification of the wire of 1.5 mm to 3.5 mm, so that the initial recrystallization temperature of the tungsten alloy wire is effectively controlled within 48% Fc to 56% Fc; in this preparation process, if the oxidation annealing process is removed, the initial recrystallization temperature of the tungsten alloy wire exceeds 56% Fc, and the excessively high initial recrystallization temperature will be detrimental to the electron emission performance of the tungsten carbide alloy filament under the working conditions of the magnetron.

(2) by Controlling the Time of Heating from A1 to A2 and the Sintering Time at A2 (1300° C. To 1500° C.) During the Sintering Process:

In the high temperature sintering stage of the tungsten compact, the present invention provides a sintering process, which controls the time of heating from A1 to A2 and the sintering time at A2 (1300° C. to 1500° C.) in the sintering process, so that the sintering neck of the tungsten compact grows rapidly, closes the holes, and prevents the oxide particles in the holes from being squeezed into another hole from the unclosed connecting channel during the shrinkage of the sintering cavity of the billet, thereby ensuring the density of the sintered billet and controlling the size of the oxide particles of the sintered billet, thereby controlling the oxide size of the tungsten alloy wire or the filament after carbonization;

Among them, the oxide particle size distribution range of the tungsten alloy sintered billet obtained by the above sintering process is 100 nm to 2000 nm, and the average size of the oxide particles is 600 nm to 1000 nm, and the average size of the oxide particles of the tungsten alloy wire is 100 nm to 500 nm; optionally, the average size of the oxide particles can also be 100 nm to 300 nm, 300 nm to 500 nm, and so on, such as 200 nm, 300 nm, 450 nm, and so on.

Without the above sintering process, the oxide particle size distribution range of the sintered tungsten alloy billet is 400 nm to 5000 nm, and the average size of the oxide particles is 1200 nm to 2000 nm. The average size of the oxide particles of the further refined tungsten alloy wire is also relatively coarse (about 500 nm to 900 nm).

The mechanism of the sintering process affecting the oxide size of the billet, tungsten alloy wire, and carbonized filament, as well as the effect of the oxide size of the tungsten alloy wire and carbonized filament on the performance of the filament is as follows: the reason why the oxide particle size is controlled within a smaller range is that the oxide particle size of the billet directly determines the oxide size of the tungsten alloy wire or carbonized filament. If the oxide particles of the wire are coarser, it will be more difficult for the particles to migrate to the surface of the filament during the use of the magnetron, which will make it easier to break the balance between the loss and replenishment of rare earth elements on the surface of the filament, making the magnetron electron emission more unstable.

The adjustment of sintering process affects the speed of sintering neck growth and pore closure of tungsten billet. The sintering process provided can reduce the possibility of oxide particle aggregation, thereby reducing the oxide particle size of sintered billet. As shown in FIG. 20, the specific principle of high temperature sintering process is explained as follows:

The isostatic pressing compact is a dense accumulation of powders with a porosity of about 35% to 45%. We can simply imagine these pores as holes with multiple channels connected, and the oxide particles are evenly distributed on the inner surface of the holes. During the high temperature sintering process, the tungsten particles bonded together form a “sintering neck”. As the sintering temperature increases, the sintering neck continues to grow and blocks the channels connecting the holes, which produces isolated holes. These isolated holes will gradually become round, making the inner surface area of the hole smaller, and then causing the originally similar small oxide particles to gather together to form larger oxide particles. As the high temperature sintering proceeds, the holes shrink further through diffusion, and the oxide particles distributed on the inner surface of the holes can only further gather to form one or several larger oxide particles.

Some of the smaller holes merge with adjacent large holes due to diffusion, or shrink before the connecting hole channels are closed. The oxide particles in these small holes will be pushed to the adjacent unclosed holes, making the unclosed holes contain more oxide than other places, which in turn causes the oxide particles to be larger than other places.

### 1. Preferred Component Characteristics for Tungsten Alloy Wire:

(1) Preferably, the tungsten alloy wire is composed of the following components: 0.0005 wt % to 0.3 wt % of a carbon element, 0.25 wt % to 2.6 wt % of an M element, 0.05 wt % to 0.5 wt % of an oxygen element, the balance being a tungsten element and inevitable impurities, and does not comprise a thorium element;
wherein the M element can be 1.28 wt % to 2.6 wt %, and the tungsten alloy filament made of the tungsten alloy material with this composition ratio is better for use in microwave ovens <800 W. The M element can be 0.25 wt % to 1.28 wt %, and the tungsten alloy filament made of the tungsten alloy material with this composition ratio is better for use in microwave ovens >800 W. Furthermore, the M element can be 0.25 wt % to 0.86 wt %, and the tungsten alloy filament made of the tungsten alloy material with this composition ratio is better for use in microwave ovens >1000 W.
(2) The oxide of M is selected from the group consisting of lanthanum oxide, yttrium oxide, scandium oxide, neodymium oxide, samarium oxide, lutetium oxide, cerium oxide, gadolinium oxide, terbium oxide, dysprosium oxide, holmium oxide, praseodymium oxide, erbium oxide, hafnium oxide, and zirconium oxide, or a combination of any two or more thereof; the carbon element is present in the tungsten alloy material in the form of carbide or carbon simple substance, and the carbide is selected from the group consisting of lanthanum carbide, zirconium carbide, yttrium carbide, hafnium carbide, and tungsten carbide. For example, the oxide of M can be selected from lanthanum oxide, or a combination of lanthanum oxide and yttrium oxide, or a combination of lanthanum oxide and zirconium oxide, or a combination of lanthanum oxide and scandium oxide, or a combination of lanthanum oxide and hafnium oxide, and so on

Preferably, the components of the tungsten alloy material further comprise T, and the T is a solid solution metal element or a dispersed metal element, and the T is selected from at least one of K, Re, Mo, Fe, and Co. Further preferably, the mass content of the Re is less than 1000 ppm.

It should be noted that:
“La, Y, Sc, Nd, Sm, Lu, Ce, Gd, Tb, Dy, Ho, Pr, Er, Tm, Yb, Eu, Hf, Zr” in the text are element symbols in the periodic table, representing the metal elements lanthanum, yttrium, scandium, neodymium, samarium, lutetium, cerium, gadolinium, terbium, dysprosium, holmium, praseodymium, erbium, thulium, ytterbium, europium, hafnium and zirconium in the periodic table respectively; “K, Re, Mo, Fe, Co” in the text are element symbols in the periodic table, representing the metal elements potassium, rhenium, molybdenum, iron and cobalt in the periodic table respectively; W is the symbol of tungsten in the periodic table; C is the symbol of carbon in the periodic table; in addition, “M” and “T” are only reference symbols and do not represent elements in the periodic table and are only used for reference.

### 2. Preferred Structural Features of the Above Tungsten Alloy Wire:

(1) The wire diameter of the above tungsten alloy wire can be 800 μm or less:

In the pressure processing step, the tungsten alloy wire provided by the present invention has good processing performance and can be processed into wires with fine wire diameter specifications (i.e., fine wire diameter tungsten alloy wire), and the wire diameter tolerance can be controlled within a very small range.

Furthermore, the wire diameter of the tungsten alloy wire can reach 600 μm or less, 550 μm or less, or even 500 μm or less. The wire diameter of the tungsten alloy wire can be 450 μm to 550 μm, such as 470 μm, 490 μm, 500 μm, 520 μm, and so on, or 700 μm to 800 μm, such as 750 μm, 760 μm, 780 μm, and so on
(2) The number of flaw detection crack points of the above tungsten alloy wire is less than 5 (per 100 meters). Further, the number of flaw detection crack points of the tungsten alloy wire can be less than 2 per 100 meters, such as 0 per 100 meters, 0.5 per 100 meters, 1 per 100 meters, and so on.

Tungsten alloy wire has fewer flaw detection crack points, higher filament yield rate, and is less likely to break.

3. After the Tungsten Alloy Wire is Carbonized, a Tungsten Carbide Alloy Filament can be Obtained. The Present Invention Further Provides the Following Preferred Embodiments of the Method for Preparing the Tungsten Carbide Alloy Filament:
Step 1, cathode assembly: assemble the spring-shaped filament structure and components, ceramics, lead pieces and other parts into a cathode structure through heat treatment;
Step 2, welding: welding the filament structure in the cathode structure and the component end cap together;
Step 3, carbonization: placing the cathode structure into a carbonization tank for carbonization, introducing carbon-containing hydrocarbon gas after exhausting, and passing a direct current of a certain current value through the cathode structure for heating, so that the filament structure is carbonized in the hydrocarbon gas, and the filament structure is carbonized to form the tungsten alloy filament;
Step 4, white ball assembly: assemble the cathode structure, anode cylinder, antenna end cap and other components together;
Step 5, blackening treatment: exhaust the white ball, evacuate it, and age it at high temperature to complete the black ball manufacturing and launch performance activation;
Step 6, heating device assembly: assemble the black ball, heat sink, magnet, tube shell, and so on, and finally obtain a heating device component containing the above-mentioned tungsten alloy filament. In this way, the obtained heating device component can be installed in the equipment (such as a microwave oven) for use.

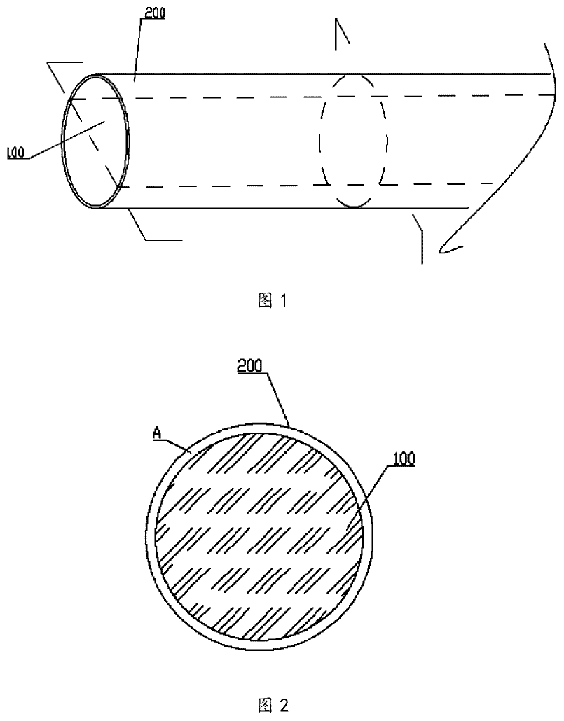

The tungsten alloy filament carbonization treatment of the present application is adopted, and the prepared tungsten alloy filament is shown in FIG. 1-FIG. 5: it includes a base body 100 and a carburized layer 200 covering the periphery of the base body 100; channels 210 are distributed on the carburized layer 200, and the channels include a first channel 211 and a second channel 212;

At least part of the first channel 211 is distributed along the radial direction of the cross section of the filament; and/or at least part of the first channel 211 points to the center of the cross section of the filament. The second channel 212 divides the carburized layer 200 into a layered structure stacked along the radial direction, and then divides the carburized layer 200 into a block structure through the first channel 211 designed to intersect with it, and the carburized layer 200 forms a layer block.

It should be noted that:

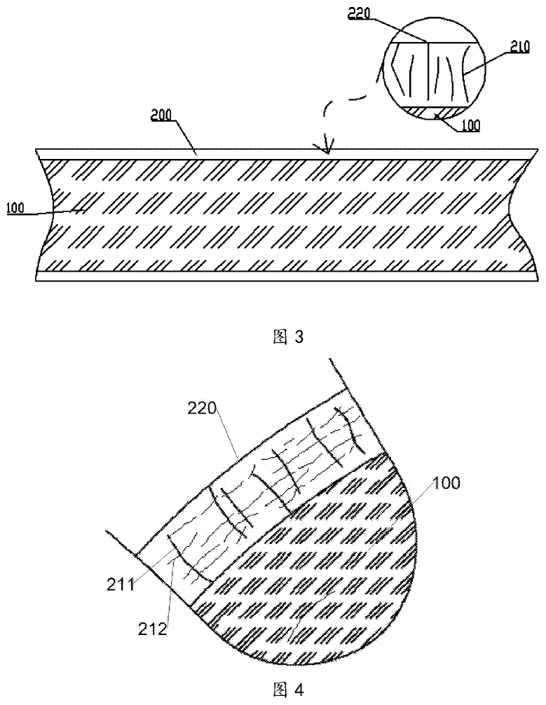

As shown in the filament structure of FIG. 1, the cross section of the filament of FIG. 2 and the longitudinal section of the filament of FIG. 3, the “radial distribution along the cross section of the filament” and “at least part of the first channel 211 points to the center of the cross section of the filament” mentioned herein. For the radial distribution and the center of the circle, it means that the end point of the first channel 211 close to the base body 100 and the end point close to the edge of the filament are connected to form a first straight line, and the angle between the first straight line and the tangent line at the intersection of the outer edge 220 of the filament is (60 to 90)°.

As shown in FIG. 5, the “circumferential distribution along the cross section of the tungsten alloy filament” described herein refers to connecting the end points of the second channel 212 into a second straight line, and the angle between the second straight line and the straight line where the filament radial direction is located is (−45 to +45)°.

In the present invention, the first channel 211 is quasi-vertical and quasi-radially distributed to the outer edge 220 of the filament (i.e., the outer edge of the carburized layer 200), but this does not mean that the first channel 211 is a straight structure, nor does it mean that the two end points of the first channel 211 need to pass through to the outer edge of the base body 100 and the carburized layer 200 (i.e., the outer edge 220 of the filament).

In the present invention, the second channel 212 is distributed along the annular direction or is cross-arranged with the first channel 211, which does not mean that the second channel 212 is a standard arc structure, and does not mean that the second channel 212 is continuously connected to pass through the entire outer ring. It can be a quasi-annular distribution composed of multiple sections of second channels 212 separated from each other, or a cross-distribution of multiple sections of second channels 212 separated from each other and the first channel 211, so that the carburized layer 200 is divided into a layered structure stacked along the radial direction.

### THE PRESENT INVENTION ALSO PROVIDES THE FOLLOWING EXAMPLES AND COMPARATIVE EXAMPLES

The weight formula of the raw material components and the element ratio of the prepared filament material of the examples and comparative examples provided by the present invention are shown in Table 1 below:

TABLE 1

| | | Component (weight percentage, %) | | |
|---|---|---|---|---|
| | Material | M metals and oxides | | |
| Number | category | thereof | Carbide | Tungsten |
| Example 1 | multicomponent | 2% La₂O₃ | 1.25% tungsten | balance |
| | rare earth | | carbide | |
| | tungsten | | | |
| Example 2 | multicomponent | 1.0% La₂O₃ + 0.2% | 1.25% tungsten | balance |
| | rare earth | Y₂O₃(total amount 1.2%) | carbide | |
| | tungsten | | | |
| Example 3 | multicomponent | 1.0% La₂O₃ + 0.2% | 1.25% tungsten | balance |
| | rare earth | ZrO₂(total amount 1.2%) | carbide | |
| | tungsten | | | |
| Example 4 | multicomponent | 1.0% La₂O₃ + 0.2% | 1.25% tungsten | balance |
| | rare earth | Sc₂O₃(total amount | carbide | |
| | tungsten | 1.2%) | | |
| Example 5 | multicomponent | O.3% La₂O₃ + 0.2% HfO₂ | 0.5% tungsten | balance |
| | rare earth | | carbide | |
| | tungsten | | | |
| Example 6 | multicomponent | 2.0% La₂O₃ + 1.0% HfO₂ | 2.0% tungsten | balance |
| | rare earth | | carbide | |
| | tungsten | | | |
| Example 7 | multicomponent | 1.0% La₂O₃ + O.08% Re | 1.25% tungsten | balance |
| | rare earth | | carbide | |
| | tungsten | | | |
| Comparative | HWTH10 | 1% ThO₂ | 0 | balance |
| Example 1 | thoriated | | | |
| | tungsten | | | |
| Comparative | multicomponent | 1.0% La₂O₃ + 0.2% Y₂O₃ | 0 | balance |
| Example 2 | rare earth | | | |
| | tungsten | | | |
| Comparative | multicomponent | 1.0% La₂O₃ + 0.2% Sc₂O₃ | 0 | balance |
| Example 3 | rare earth | | | |
| | tungsten | | | |
| Comparative | multicomponent | 1.0% La₂O₃ + O.15% Re | 1.25% tungsten | balance |
| Example 4 | rare earth | | carbide | |
| | tungsten | | | |
| Comparative | multicomponent | 2% La₂O₃ | 1.25% tungsten | balance |
| Example 5 | rare earth | | carbide | |
| | tungsten | | | |
| Comparative | multicomponent | 2% La₂O₃ | 1.25% tungsten | balance |
| Example 6 | rare earth | | carbide | |
| | tungsten | | | |

The balance of tungsten = mass percentage 100%-the mass percentage of M metals and oxides thereof −
the mass percentage of carbides − the mass percentage of inevitable impurities.
Element ratio

| | | | | | Existence | |
|---|---|---|---|---|---|---|
| | Component (weight percentage, %) | | | | form of | Existence |
| | Tungsten | Rare earth | Oxygen | Carbon | Rare Earth | form of |
| Number | element | element | element | element | Elements | carbon element |
| Example 1 | balance | La element | 0.29% | 0.0765% | lanthanum oxide | tungsten carbide |
| | | 1.71% | | | | |
| Example 2 | balance | La element | 0.20% | 0.0765% | lanthanum | tungsten carbide |
| | | 0.86% + Y | | | oxide + yttrium | |
| | | element | | | oxide | |
| | | 0.14%(total | | | | |
| | | amount | | | | |
| | | 1.00%) | | | | |
| Example 3 | balance | La element | 0.20% | 0.0765% | lanthanum | tungsten carbide |
| | | 0.86% + Zr | | | oxide + zirconium | |
| | | element | | | oxide | |
| | | 0.14%(total | | | | |
| | | amount | | | | |
| | | 1.00%) | | | | |
| Example 4 | balance | La element | 0.20% | 0.0765% | lanthanum | tungsten carbide |
| | | 0.86% + Sc | | | oxide + scandium | |
| | | element | | | oxide | |
| | | 0.14%(total | | | | |
| | | amount | | | | |
| | | 1.00%) | | | | |
| Example 5 | balance | La element | 0.10% | 0.0306% | lanthanum | tungsten carbide |
| | | 0.26% + Hf | | | oxide + hafnium | |
| | | element | | | oxide | |
| | | 0.14%(total | | | | |
| | | amount | | | | |
| | | 0.40%) | | | | |
| Example 6 | balance | La element | 0.45% | 0.1224% | lanthanum | tungsten carbide |
| | | 1.71% + Hf | | | oxide + hafnium | |
| | | element | | | oxide | |
| | | 0.84%(total | | | | |
| | | amount | | | | |
| | | 2.55%) | | | | |
| Example 7 | balance | La element | 0.14% | 0.0765% | lanthanum | tungsten carbide |
| | | 0.86% + Reele | | | oxide + rhenium | |
| | | ment0.08%(t | | | | |
| | | otal amount | | | | |
| | | 0.94%) | | | | |
| Comparative | balance | Th element | 0.12% | | thorium oxide | |
| Example 1 | | 0.88% | | | | |
| Comparative | balance | La element | 0.20% | | lanthanum | |
| Example 2 | | 0.86% + Y | | | oxide + yttrium | |
| | | element0.14 | | | oxide | |
| Comparative | balance | La element | 0.20% | | lanthanum | |
| Example 3 | | 0.86% + Sc | | | oxide + scandium | |
| | | element | | | oxide | |
| | | 0.14% | | | | |
| Comparative | balance | La element | 0.14% | 0.0765% | lanthanum | tungsten carbide |
| Example 4 | | 0.86% + Re | | | oxide + rhenium | |
| | | element | | | | |
| | | 0.15%(total | | | | |
| | | amount | | | | |
| | | 1.01%) | | | | |
| Comparative | balance | La element | 0.29% | 0.0765% | lanthanum oxide | tungsten carbide |
| Example 5 | | 1.71% | | | | |
| Comparative | balance | La element | 0.29% | 0.0765% | lanthanum oxide | tungsten carbide |
| Example 6 | | 1.71% | | | | |

The balance tungsten content = 100% − the mass percentage of rare earth element − the mass percentage of carbon element − the mass percentage of oxygen element-the mass percentage of inevitable impurities.

Specifically, according to the formula in Table 1, the raw material components in the examples and the comparative examples are prepared according to the following preparation method to prepare a tungsten alloy filament and a heating device:

### Example 1

1. According to the formula in Table 1, 5 L of deionized water was added to a certain amount of lanthanum nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate solution to ammonia NH₃·H₂O solution was 5:1
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum doped powder with uniform doping and low impurity content was obtained;
4. The tungsten-lanthanum doped powder was first reduced to tungsten-lanthanum powder of appropriate particle size in reduction furnaces with temperatures of 650° C., 750° C., 850° C. and 900° C. in the four temperature zones.
5. The obtained tungsten-lanthanum powder and tungsten carbide were loaded into a high-speed powder mixer for solid-solid powder mixing for 2 hours, and then sieved to obtain mixed tungsten-lanthanum alloy powder;
6. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. The high temperature sintering method was adopted, and the intermediate holding point used the method of rapid temperature rise and extended holding time. The sintering temperature curve was as follows:
heating from room temperature to A1, wherein the heating time H1 was 6 hours, A1 was 1100° C.; keeping warm at A1 for H2 hours, wherein H2 was 2 hours; heating from A1 to A2, wherein the heating time was H3, H3 was 2 hours, A2 was 1400° C.; keeping warm at A2 for H4 hours, wherein H4 was 3.5 hours; heating from A2 to A3, wherein the heating time was H5, H5 was 2 hours, A3 was 1800° C.; keeping warm at A3 for H6 hours, wherein H6 was 2 hours; heating from A3 to A4, wherein the heating time was H7, H7 was 2 hours, A4 was 2100° C.; keeping warm at A4 for H8 hours, wherein H8 was 6 hours; and cooling naturally from A4 to obtain the tungsten alloy sintered billet. The pore closing and shrinking speed of the billet was controlled by controlling the medium frequency sintering time, thereby obtaining a sintered billet with an oxide particle size of <2.0 μm and a density of 18.0 g/cm³.
8. Multiple rotary forging and drawing processes were used to process the 17 mm diameter sintered billet into 2.0 mm specification wire, and then oxidation annealing was performed on the oxidation annealing equipment, with the annealing conditions as follows: temperature 1400° C., annealing speed 5 m/min; after annealing, the wire was continued to process into 0.52 mm±0.005 mm diameter rare earth tungsten alloy black wire;
The multi-pass rotary forging and drawing processing adopts conventional drawing process, and the process parameters are multi-pass rotary forging to a wire diameter specification of 3.7 mm, then drawing to 2.0 mm, and then further processing to 0.52±0.005 mm tungsten lanthanum alloy black wire after annealing.
9. The 0.52 mm black filament was cleaned by electrolytic cleaning into 0.50 mm±0.005 mm tungsten lanthanum alloy white filament, which could be processed into the filament of microwave oven heating device.
10. The 0.50 mm tungsten-lanthanum alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 2

1. According to the formula in Table 1, 5 L of deionized water was added to a certain amount of lanthanum nitrate-yttrium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-yttrium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-yttrium doped powder with uniform doping and low impurity content was obtained;
4. The tungsten-lanthanum-yttrium doped powder was first reduced to tungsten-lanthanum-yttrium powder of appropriate particle size in reduction furnaces with temperatures of 650° C., 750° C., 850° C. and 900° C. in the four temperature zones.
5. The obtained tungsten-lanthanum-yttrium powder and tungsten carbide were loaded into a high-speed powder mixer for solid-solid powder mixing for 2 hours, and then sieved to obtain mixed tungsten-lanthanum-yttrium alloy powder;
6. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. The high temperature sintering method was adopted, and the intermediate holding point used the method of rapid temperature rise and extended holding time. The sintering temperature curve was as follows:
heating from room temperature to A1, wherein the heating time H1 was 5 hours, A1 was 950° C.; keeping warm at A1 for H2 hours, wherein H2 was 3 hours; heating from A1 to A2, wherein the heating time was H3, H3 was 1.5 hours, A2 was 1300° C.; keeping warm at A2 for H4 hours, wherein H4 was 4.5 hours; heating from A2 to A3, the heating time was H5, H5 was 1 hour, A3 was 1700° C.; keeping warm at A3 for H6 hours, wherein H6 was 3 hours; heating from A3 to A4, wherein the heating time was H7, H7 was 1 hour, A4 was 2050° C.; keeping warm at A4 for H8 hours, wherein H8 was 10 hours; cooling naturally from A4 to obtain the tungsten alloy sintered billet.
8. Multiple rotary forging and drawing processes were used to process the 17 mm diameter sintered billet into 2.0 mm specification wire, and then oxidation annealing was performed on the oxidation annealing equipment, with the annealing conditions as follows: temperature 1200° C., annealing speed 3 m/min; after annealing, the wire was continued to process into 0.52 mm±0.005 mm diameter tungsten-lanthanum-yttrium alloy black wire; other conditions were consistent with Example 1.
9. The 0.52 mm black filament was cleaned by electrolytic cleaning into 0.50 mm±0.005 mm tungsten-lanthanum-yttrium alloy white filament, which could be processed into the filament of microwave oven heating device.
10. The 0.50 mm tungsten-lanthanum-yttrium alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 3

1. According to the formula in Table 1, 5 L of deionized water was added to a certain amount of lanthanum nitrate-zirconium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-zirconium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-zirconium doped powder with uniform doping and low impurity content was obtained;
4. The tungsten-lanthanum doped powder was first reduced to tungsten-lanthanum-zirconium powder of appropriate particle size in reduction furnaces with temperatures of 650° C., 750° C., 850° C. and 900° C. in the four temperature zones.
5. The obtained tungsten-lanthanum-zirconium powder and tungsten carbide were loaded into a high-speed powder mixer for solid-solid powder mixing for 2 hours, and sieved to obtain mixed tungsten-lanthanum alloy powder;
6. The powder with a particle size of 1.5 μm was pressed into a compact with a single weight of 3.0 kg at a pressure of 180 MPa by was ostatic pressing, and the compact was pre-sintered at a low temperature in a hydrogen atmosphere to increase the strength of the compact;
7. The high temperature sintering method was adopted, and the intermediate holding point used the method of rapid temperature rise and extended holding time. The sintering temperature curve was as follows:
heating from room temperature to A1, wherein the heating time H1 was 8 hours, A1 was 1250° C.; keeping warm at A1 for H2 hours, wherein H2 was 1 hour; heating from A1 to A2, wherein the heating time was H3, H3 was 2.5 hours, A2 was 1400° C.; keeping warm at A2 for H4 hours, wherein H4 was 2.5 hours; heating from A2 to A3, wherein the heating time was H5, H5 was 3 hours, A3 was 1900° C.; keeping warm at A3 for H6 hours, wherein H6 was 1 hour; heating from A3 to A4, wherein the heating time was H7, H7 was 3 hours, A4 was 2250° C.; keeping warm at A4 for H8 hours, wherein H8 was 5 hours; cooling naturally from A4 to obtain the tungsten alloy sintered billet.
8. Multiple rotary forging and drawing processes were used to process the 17 mm diameter sintered billet into 2.0 mm specification wire, and then oxidation annealing was performed on the oxidation annealing equipment, with the annealing conditions as follows: temperature 1500° C., annealing speed 10 m/min; after annealing, the wire was continued to process into 0.52 mm±0.005 mm diameter tungsten-lanthanum-zirconium alloy black wire; other conditions were consistent with Example 1.
9. The 0.52 mm black filament was cleaned by electrolytic cleaning into 0.50 mm±0.005 mm tungsten-lanthanum-zirconium alloy white filament, which could be processed into the filament of microwave oven heating device, other conditions were consistent with Example 1.
10. The 0.50 mm tungsten-lanthanum-zirconium alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 4

1. According to the formula in Table 1, 5 L of deionized water was added to a certain amount of lanthanum nitrate-scandium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-scandium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-scandium doped powder with uniform doping and low impurity content was obtained;
4. The tungsten-lanthanum-scandium doped powder was first reduced to tungsten-lanthanum-scandium powder of appropriate particle size in reduction furnaces with temperatures of 650° C., 750° C., 850° C. and 900° C. in the four temperature zones.
5. The obtained tungsten-lanthanum-scandium powder and tungsten carbide were loaded into a high-speed powder mixer for solid-solid powder mixing for 2 hours, and then sieved to obtain mixed tungsten-lanthanum-scandium alloy powder;
6. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. Wherein, the process and conditions of this step were consistent with those of Example 1;
8. Multiple rotary forging and drawing processes were used to process the 17 mm diameter sintered billet into 0.52 mm±0.005 mm diameter tungsten-lanthanum-scandium alloy black wire; the process and conditions of this step were consistent with those of Example 1;
9. The 0.52 mm black filament was cleaned by electrolytic cleaning into 0.50 mm±0.005 mm tungsten-lanthanum-scandium alloy white filament, which could be processed into the filament of microwave oven heating device.
10. The 0.50 mm tungsten-lanthanum alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 5

1. According to the formula in Table 1, 5 L of deionized water was added to a certain amount of lanthanum nitrate-hafnium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-hafnium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-hafnium doped powder with uniform doping and low impurity content was obtained;
4. The tungsten-lanthanum-hafnium doped powder was first reduced to tungsten-lanthanum-hafnium powder of appropriate particle size in reduction furnaces with temperatures of 650° C., 750° C., 850° C. and 900° C. in the four temperature zones.
5. The obtained tungsten-lanthanum-hafnium powder and tungsten carbide were loaded into a high-speed powder mixer for solid-solid powder mixing for 2 hours, and then sieved to obtain mixed tungsten-lanthanum-hafnium alloy powder with a content of 0.3% La₂O₃30 0.2% HfO₂+0.5% WC;
6. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. Wherein, the process and conditions of this step were consistent with those of Example 1;
8. Multiple rotary forging and drawing processes were used to process the 17 mm diameter sintered billet into 0.52 mm±0.005 mm diameter tungsten-lanthanum-hafnium alloy black wire; the process and conditions of this step were consistent with those of Example 1;
9. The 0.52 mm black filament was cleaned by electrolytic cleaning into 0.50 mm±0.005 mm tungsten-lanthanum-hafnium alloy white filament, which could be processed into the filament of microwave oven heating device.
10. The 0.50 mm tungsten-lanthanum-hafnium alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 6

1. According to the formula in Table 1, 5 L of deionized water was added to a certain amount of lanthanum nitrate-hafnium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-hafnium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-hafnium doped powder with uniform doping and low impurity content was obtained;
4. The tungsten-lanthanum-hafnium doped powder was first reduced to tungsten-lanthanum-hafnium powder of appropriate particle size in reduction furnaces with temperatures of 650° C., 750° C., 850° C. and 900° C. in the four temperature zones.
5. The obtained tungsten-lanthanum-hafnium powder and tungsten carbide were loaded into a high-speed powder mixer for solid-solid powder mixing for 2 hours, and then sieved to obtain mixed tungsten-lanthanum-hafnium alloy powder with a content of 0.3% La₂O₃+0.2% HfO₂+0.5% WC;
6. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. The process and conditions of this step were consistent with those of Example 1;
8. Multiple rotary forging and drawing processes were used to process the 17 mm diameter sintered billet into 0.52 mm±0.005 mm diameter tungsten-lanthanum-hafnium alloy black wire; the process and conditions of this step were consistent with those of Example 1;
9. The 0.52 mm black filament was cleaned by electrolytic cleaning into 0.50 mm±0.005 mm tungsten-lanthanum-hafnium alloy white filament, which could be processed into the filament of microwave oven heating device.
10. The 0.50 mm tungsten-lanthanum-hafnium alloy white wire was wound into a spring-shaped cathode filament for heating devices, with 10 turns and a pitch of 1.29=0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Example 7

1. According to the formula in Table 1, 5 L of deionized water was added to a certain amount of lanthanum nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum doped powder with uniform doping and low impurity content was obtained;
4. The tungsten-lanthanum doped powder was first reduced to tungsten-lanthanum powder of appropriate particle size in reduction furnaces with temperatures of 650° C., 750° C., 850° C. and 900° C. in the four temperature zones.
5. According to the formula in Table 1, 5 L of deionized water was added into the doping pot and heated to 80° C., then a certain amount of ammonium rhenate were added, stirred for 10 minutes to fully dissolve, a certain amount of tungsten lanthanum powder was added into the ammonium rhenate solution and stirred for 30 minutes, then the powder was dried by steam heating under vacuum, the steam pressure was 0.1 MPa to 0.3 MPa, the vacuum degree in the pot was ≤−0.02 MPa, and finally rhenium-doped tungsten lanthanum powder with uniform doping and low impurity content was obtained;
6. The rhenium-doped tungsten lanthanum powder was first reduced to tungsten-lanthanum-rhenium of particle size of 1.5 μm in reduction furnaces with temperatures of 650° C., 750° C., 850° C. and 900° C. in the four temperature zones.
7. The obtained tungsten-lanthanum-rhenium alloy powder and tungsten carbide were loaded into a high-speed powder mixer for solid-solid powder mixing for 2 hours, and sieve to obtain mixed tungsten-lanthanum-rhenium alloy powder;
8. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
9. Sintered billets with oxide particle size <2.0 μm and density 18.0 g/cm were obtained by high temperature sintering. The process and conditions of this step were consistent with those of Example 1;
10. Multiple rotary forging and drawing processes were used to process the 17 mm diameter sintered billet into 0.52 mm±0.005 mm diameter tungsten-lanthanum-rhenium alloy black wire; the process and conditions of this step were consistent with those of Example 1;
11. The 0.52 mm black filament was cleaned by electrolytic cleaning into 0.50 mm±0.005 mm tungsten-lanthanum-rhenium alloy white filament, which can be processed into the filament of microwave oven heating device.
12. The 0.50 mm tungsten-lanthanum-rhenium alloy white wire was wound into a spring-shaped cathode filament for heating devices, with 10 turns and a pitch of 1.29±0.03 mm.
13. The filament was assembled into a cathode structure with components such as assemblies, ceramics, and lead plates through heat treatment, and the heat treatment temperature was 600° C.
14. The filament in the cathode structure and the end cap of the component were welded together.
15. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
16. White ball assembly: the cathode structure, anode cylinder, antenna end cap and other components were assembled together.
17. The white balls were subjected to exhaust, vacuuming and high-temperature aging to complete the manufacturing of the black balls and the activation of their emission performance.
18. The black ball, heat sink, magnet, tube shell, and so on were assembled to finally obtain the heating device component containing the above-mentioned filament, and put into a microwave oven for use.

### Comparative Example 1

1. According to the formula in Table 1, 5 L of deionized water was added to a certain amount of thorium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of thorium nitrate solution to ammonia NH₃·H₂O solution was 5:1
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally thorium-tungsten doped powder with uniform doping and low impurity content was obtained;
4. The tungsten-lanthanum doped powder was first reduced to thorium-tungsten powder of particle size of 1.5 μm in reduction furnaces with temperatures of 650° C., 750° C., 850° C. and 900° C. in the four temperature zones.
5. The obtained tungsten-lanthanum powder and tungsten carbide were loaded into a V-shaped powder mixer for solid-solid powder mixing for 2 hours, and then sieved to obtain mixed tungsten-lanthanum alloy powder;
6. The tungsten-lanthanum powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. The process and conditions of this step were consistent with those of Example 1;
8. Multiple rotary forging and drawing processes were used to process the 17 mm diameter sintered billet into 0.52 mm±0.005 mm diameter thorium-tungsten alloy black wire; the process and conditions of this step were consistent with those of Example 1;
9. The 0.52 mm black filament was cleaned by electrolytic cleaning into 0.50 mm±0.005 mm thorium-tungsten alloy white filament, which could be processed into the filament of microwave oven heating device.
10. The 0.50 mm thorium-tungsten alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Comparative Example 2

1. According to the formula in Table 1, 5 L of deionized water was added to a certain amount of lanthanum nitrate-yttrium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-yttrium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-yttrium doped powder with uniform doping and low impurity content was obtained;
4. The tungsten-lanthanum-yttrium doped powder was first reduced to tungsten-lanthanum-yttrium powder of particle size of 1.5 μm in reduction furnaces with temperatures of 650° C., 750° C., 850° C. and 900° C. in the four temperature zones.
5. The obtained tungsten-lanthanum-yttrium powder and tungsten carbide were loaded into a V-shaped powder mixer for solid-solid powder mixing for 2 hours, and then sieved to obtain mixed tungsten-lanthanum-yttrium alloy powder;
6. The tungsten-lanthanum-yttrium powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. The process and conditions of this step were consistent with those of Example 1;
8. Multiple rotary forging and drawing processes were used to process the 17 mm diameter sintered billet into 0.52 mm±0.005 mm diameter rare tungsten-lanthanum-yttrium alloy black wire; the process and conditions of this step were consistent with those of Example 1;
9. The 0.52 mm black filament was cleaned by electrolytic cleaning into 0.50 mm±0.005 mm tungsten-lanthanum-yttrium alloy white filament, which could be processed into the filament of microwave oven heating device.
10. The 0.50 mm tungsten-lanthanum-yttrium alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Comparative Example 3

1. According to the formula in Table 1, 5 L of deionized water was added to a certain amount of lanthanum nitrate-scandium nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate-scandium nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum-scandium doped powder with uniform doping and low impurity content was obtained;
4. The tungsten-lanthanum-scandium doped powder was first reduced to tungsten-lanthanum-scandium powder of particle size of 1.5 μm in reduction furnaces with temperatures of 650° C., 750° C., 850° C. and 900° C. in the four temperature zones.
5. The obtained tungsten-lanthanum powder and tungsten carbide were loaded into a V-shaped powder mixer for solid-solid powder mixing for 2 hours, and then sieved to obtain mixed tungsten-lanthanum-scandium alloy powder;
6. The tungsten-lanthanum powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
7. Sintered billets with oxide particle size <2.0 μm and density 18.0 g/cm were obtained by high temperature sintering. The process and conditions of this step were consistent with those of Example 1;
8. Multiple rotary forging and drawing processes were used to process the 17 mm diameter sintered billet into 0.52 mm±0.005 mm diameter tungsten-lanthanum-scandium alloy black wire; the process and conditions of this step were consistent with those of Example 1;
9. The 0.52 mm black filament was cleaned by electrolytic cleaning into 0.50 mm±0.005 mm tungsten-lanthanum-scandium alloy white filament, which could be processed into the filament of microwave oven heating device.
10. The 0.50 mm tungsten-lanthanum alloy white wire was wound into a spring-shaped cathode filament for heating devices, with 10 turns and a pitch of 1.29±0.03 mm.
11. The filament was assembled into a cathode structure with components such as assemblies, ceramics, and lead plates through heat treatment, and the heat treatment temperature was 600° C.
12. The filament in the cathode structure and the end cap of the component were welded together.
13. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
14. White ball assembly: the cathode structure, anode cylinder, antenna end cap and other components were assembled together.
15. The white balls were subjected to exhaust, vacuuming and high-temperature aging to complete the manufacturing of the black balls and the activation of their emission performance.
16. The black ball, heat sink, magnet, tube shell, and so on were assembled to finally obtain the heating device component containing the above-mentioned filament, which was then put into a microwave oven for use.

### Comparative Example 4

1. According to the formula in Table 1, 5 L of deionized water was added to a certain amount of lanthanum nitrate solution, stirred for 10 minutes to fully dissolve, then 1 L of ammonia NH₃·H₂O solution was added and stirred to neutralize, and the prepared mixed solution was evenly sprayed onto the blue tungsten placed in the doping pot and stirred; wherein, the volume ratio of lanthanum nitrate solution to ammonia NH₃·H₂O solution was 5:1;
2. The doping pot was evacuated and heated with water (heating temperature 80° C., vacuum degree-0.025 MPa), and stirring was carried out while heating;
3. Under vacuum, the powder was dried by steam heating, the steam pressure was 0.1 MPa to 0.3 MPa, the vacuum degree in the pot was ≤−0.02 MPa, and finally tungsten-lanthanum doped powder with uniform doping and low impurity content was obtained;
4. The tungsten-lanthanum doped powder was first reduced to tungsten-lanthanum powder of particle size of 1.5 μm in reduction furnaces with temperatures of 650° C., 750° C., 850° C. and 900° C. in the four temperature zones.
5. According to the formula in Table 1, 5 L of deionized water was added into the doping pot and heated to 80° C., then a certain amount of ammonium rhenate were added, stirred for 10 minutes to fully dissolve, a certain amount of tungsten lanthanum powder were added into the ammonium rhenate solution and stirred for 30 minutes, then the powder was dried by steam heating under vacuum, the steam pressure was 0.1 MPa to 0.3 MPa, the vacuum degree in the pot was ≤−0.02 MPa, and finally rhenium-doped tungsten lanthanum powder with uniform doping and low impurity content was obtained;
6. The rhenium-doped tungsten lanthanum powder was first reduced to tungsten-lanthanum-rhenium powder of particle size of 1.5 μm in reduction furnaces with temperatures of 650° C., 750° C., 850° C. and 900° C. in the four temperature zones.
7. The obtained tungsten-lanthanum-rhenium alloy powder and tungsten carbide were loaded into a high-speed powder mixer for solid-solid powder mixing for 2 hours, and the sieved to obtain mixed tungsten-lanthanum-rhenium alloy powder;
8. The powder with a particle size of 1.5 μm was pressed into a compact with a single weight of 3.0 kg at a pressure of 180 MPa by isostatic pressing, and the compact was pre-sintered at a low temperature in a hydrogen atmosphere to increase the strength of the compact;
9. Sintered billets with oxide particle size <2.0 μm and density 18.0 g/cm were obtained by high temperature sintering. The process and conditions of this step were consistent with those of Example 1;
10. Multiple rotary forging and drawing processes were used to process the 17 mm diameter sintered billet into 0.52 mm±0.005 mm diameter tungsten-lanthanum-rhenium alloy black wire; the process and conditions of this step were consistent with those of Example 1;
11. The 0.52 mm black filament was cleaned by electrolytic cleaning into 0.50 mm±0.005 mm tungsten-lanthanum-rhenium alloy white filament, which could be processed into the filament of microwave oven heating device.
12. The 0.50 mm tungsten-lanthanum-rhenium alloy white wire was wound into a spring-shaped cathode filament for heating devices, with 10 turns and a pitch of 1.29±0.03 mm.
13. The filament was assembled into a cathode structure with components such as assemblies, ceramics, and lead plates through heat treatment, and the heat treatment temperature was 600° C.
14. The filament in the cathode structure and the end cap of the component were welded together.
15. The cathode structure was placed in the carbonization tank for carbonization. After exhaust, carbon-containing hydrocarbon gas (specifically methane) was introduced, and a certain current value (16 A) of direct current was supplied to the cathode for heating, allowing the filament to complete carbonization in the hydrocarbon gas.
16. White ball assembly: the cathode structure, anode cylinder, antenna end cap and other components were assembled together.
17. The white balls were subjected to exhaust, vacuuming and high-temperature aging to complete the manufacturing of the black balls and the activation of their emission performance.
18. The black ball, heat sink, magnet, tube shell, and so on were assembled to finally obtain the heating device component containing the above-mentioned filament, which was then put into a microwave oven for use.

### Comparative Example 5

The difference between this comparative example and Example 1 was only that:

In this comparative example, in the multi-pass rotary forging and drawing process, the sintered billet with a diameter of 17 mm was directly processed into a tungsten-lanthanum-tungsten alloy black wire with a diameter of 0.52 mm±0.005 mm, and the wire diameter of the intermediate specification was not processed by the oxidation annealing process. Other processes and process conditions were consistent with those in Example 1.

### Comparative Example 6

The difference between this comparative example and Example 1 was only that:

In this comparative example, the temperature rise curve of the high-temperature sintering is as follows: heating from room temperature to A1, the temperature rise time H1 is 6 hours, A1 is 1100° C.; keep warm at A1 for H2 hours, H2 is 2 hours; from A1 to A2, the temperature rise time is H3, H3 is 3 hours, A2 is 1400° C.; keep warm at A2 for H4 hours, H4 is 2 hours; from A2 to A3, the temperature rise time is H5, H5 is 2 hours, A3 is 1800° C.; keep warm at A3 for H6 hours, H6 is 2 hours; from A3 to A4, the temperature rise time is H7, H7 is 2 hours, A4 is 2100° C.; keep warm at A4 for H8 hours, H8 is 6 hours; cool naturally from A4, and obtain. Other processes and process conditions are consistent with those in Example 1.

The tungsten alloy wires, tungsten alloy filaments and devices (microwave ovens) containing the filament components prepared in the above embodiments and comparative examples are tested for relevant performance indicators under the same test conditions. The test results are shown in Tables 2-7 below:

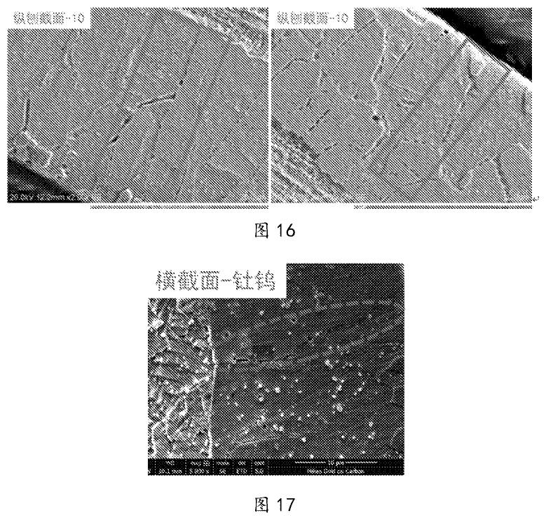

TABLE 2
Carbonized tungsten alloy filament

| | | | | | | Particle | |
|---|---|---|---|---|---|---|---|
| | | | Average | | Mass | size of M | |
| | | | grain | | percentage | oxide | |
| | | Number of grains of | width of | Thickness of | of W₂C and | particles | Distribution of |
| | | the tungsten base body | carburized | carburized | WC in | in the | channels 210 |
| | Wire resistance | 100 after | layer | layer 200 | carburized | carburized | in carburized |
| Number | (mΩ/200 mm length) | carburization(/mm²) | 200( μm) | (μm) | layer 200 | layer 200 | layer 200 |
| Example 1 | 73.2 | 4000 | 6.83 | 38.5 | 80:20 | 10 nm | As shown in |
| | | | | | | 1000 nm | FIGS. 15-16, a |
| | | | | | | | first channel |
| | | | | | | | 211 and a |
| | | | | | | | second channel |
| | | | | | | | 212 are |
| | | | | | | | included. The |
| | | | | | | | first channel |
| | | | | | | | 211 is |
| | | | | | | | perpendicular |
| | | | | | | | to the outer |
| | | | | | | | edge 220 of the |
| | | | | | | | filament, and |
| | | | | | | | the second |
| | | | | | | | channel 212 |
| | | | | | | | intersects with |
| | | | | | | | the first |
| | | | | | | | channel 211 in |
| | | | | | | | a circular |
| | | | | | | | distribution. |
| | | | | | | | The carburized |
| | | | | | | | layer 200 |
| | | | | | | | forms a layered |
| | | | | | | | block. |
| Example 2 | 73 | 2000 | 7.77 | 38 | 80:20 | 10 nm to | Same as |
| | | | | | | 1000 nm | Example 1 |
| Example 3 | 72.8 | 2000 | 7.42 | 37 | 80:20 | 10 nm to | Same as |
| | | | | | | 1000 nm | Example 1 |
| Example 4 | 73.1 | 2000 | 7.5 | 37.5 | 80:20 | 10 nm to | Same as |
| | | | | | | 1000 nm | Example 1 |
| Example 5 | 65 | 1000 | 7.85 | 35.5 | 70:30 | 10 nm to | Same as |
| | | | | | | 1000 nm | Example 1 |
| Example 6 | 77 | 8000 | 4.22 | 40 | 80:20 | 10 nm to | Same as |
| | | | | | | 1000 nm | Example 1 |
| Example 7 | 73.4 | 6000 | 6.49 | 39.2 | 80:20 | 10 nm to | Same as |
| | | | | | | 1000 nm | Example 1 |
| Comparative | 68.5 | 100 | 9.81 | 36.5 | 65:35 | — | As shown in |
| Example 1 | | | | | | | FIG.16, there |
| | | | | | | | were a small |
| | | | | | | | number of first |
| | | | | | | | channels 211 |
| | | | | | | | perpendicular |
| | | | | | | | to the edge of |
| | | | | | | | the filament, |
| | | | | | | | but the number |
| | | | | | | | is relatively |
| | | | | | | | reduced |
| | | | | | | | compared to |
| | | | | | | | Example, and |
| | | | | | | | there were also |
| | | | | | | | a small number |
| | | | | | | | of parallel |
| | | | | | | | second |
| | | | | | | | channels 212, |
| | | | | | | | which cannot |
| | | | | | | | form a layered |
| | | | | | | | block structure. |
| Comparative | 72 | 300 | 16.22 | 38 | 80:20 | — | Channel 210 is |
| Example 2 | | | | | | | perpendicular |
| | | | | | | | to the edge of |
| | | | | | | | the filament, |
| | | | | | | | with a small |
| | | | | | | | amount |
| | | | | | | | parallel, and |
| | | | | | | | the carburized |
| | | | | | | | layer 200 has a |
| | | | | | | | block structure |
| Comparative | 72.2 | 300 | 14.57 | 38.5 | 80:20 | — | Channel 210 is |
| Example 3 | | | | | | | perpendicular |
| | | | | | | | to the edge of |
| | | | | | | | the filament, |
| | | | | | | | with a small |
| | | | | | | | amount |
| | | | | | | | parallel, and |
| | | | | | | | the carburized |
| | | | | | | | layer 200 has a |
| | | | | | | | block structure |
| Comparative | 73.6 | 8000 | 5.65 | 39.5 | 80:20 | — | Channel 210 is |
| Example 4 | | | | | | | perpendicular |
| | | | | | | | to the edge of |
| | | | | | | | the filament |
| | | | | | | | and points |
| | | | | | | | towards the |
| | | | | | | | center of a |
| | | | | | | | circle of the |
| | | | | | | | filament cross |
| | | | | | | | section |

TABLE 3
0.5 mm tungsten alloy wire

| | | | | 80% Fc |
|---|---|---|---|---|
| | | Flaw | | Recrys- |
| | | detection | Cumu- | tallization |
| | Recrys- | (number of | lative | average |
| | tallization | cracks/100 | yield | grain |
| Number | temperature | meters) | rate(%) | size(μm) |
| Example 1 | 50% FC | 0.5-1.0/100 | 65% | 5.05 |
| | | meters | | |
| Example 2 | 50% FC | 0.6-1.5/100 | 60% | 5.6 |
| | | meters | | |
| Example 3 | 50% FC | 0.6-1.5/100 | 63% | 5.52 |
| | | meters | | |
| Example 4 | 50% FC | 1.0-2.0/100 | 62% | 5.73 |
| | | meters | | |
| Example 5 | 48% FC | 0.2-0.5/100 | 70% | 6.86 |
| | | meters | | |
| Example 6 | 52% FC | 2.0-3.0/100 | 58% | 4.88 |
| | | meters | | |
| Example 7 | 52% FC | 0.8-1.5/100 | 64% | 5.42 |
| | | meters | | |
| Comparative | 46% FC | 8.0-12.0/100 | 50% | 18.62 |
| Example 1 | | meters | | |
| Comparative | 46% FC | 0.6-1.5/100 | 62% | 12.14 |
| Example 2 | | meters | | |
| Comparative | 46% FC | 0.6-1.5/100 | 65% | 10.68 |
| Example 3 | | meters | | |
| Comparative | 54% FC | 6.0-10.0/100 | 50% | 4.33 |
| Example 4 | | meters | | |

Note:
The yield rate statistics refer to the yield rate from billet to finished filament.

TABLE 4

| | Electronic | Emission | Electron | | |
|---|---|---|---|---|---|
| | work | performance | emission | | |
| | function | stabilization | performance | Working | Working |
| Number | (Ev) | time(minutes) | (mA) | temperature, ° C. | life |
| Example 1 | 2.60 | 30 | 850 | 1150 | >500 h |
| Example 2 | 2.55 | 30 | 650 | 1200 | >500 h |
| Example 3 | 2.65 | 30 | 740 | 1250 | >500 h |
| Example 4 | 2.75 | 30 | 700 | 1180 | >500 h |
| Example 5 | 2.86 | 30 | 550 | 1200 | >500 h |
| Example 6 | 2.48 | 30 | 1020 | 1220 | >500 h |
| Example 7 | 2.68 | 30 | 600 | 1180 | >500 h |
| Comparative | 2.64 | 30 | 350 | 1600 | >500 h |
| Example 1 | | | | | |
| Comparative | 2.98 | 5 | 260 | 1500 | <200 h |
| Example 2 | | | | | |
| Comparative | 2.92 | 12 | 300 | 1400 | <200 h |
| Example 3 | | | | | |
| Comparative | 2.70 | 20 | 600 | 1200 | <300 h |
| Example 4 | | | | | |

| | |
|---|---|
| Characterization | Filament testing conditions: Ib = 300 mA, Ef = 3.3 V, then test the |
| project for | stability of anode voltage, power frequency, and filament waveform. |
| stable launch | If it works stably for 30 minutes, it is considered qualified |
| performance | |

TABLE 5
Data comparison table of Example 1, Comparative Example 1 (Thorium
Tungsten) and Comparative Examples 5-6

| | | Number of | | | | |
|---|---|---|---|---|---|---|
| | | grains in | Average | | Mass | |
| | Wire | carburized | grain | Thickness of | percentage | |
| | resistance | tungsten | width of | carbonized | of W₂C | |
| | (mΩ/200 | base body | carburized | layer | and WC in | Particle size of M |
| | mm | 100 | layer | 200 | carburized | oxide particles in the |
| Number | length) | (pcs/mm²) | 200(μm) | (μm) | layer 200 | carburized layer 200 |
| Example 1 | 73.2 | 4000 | 6.83 | 38.5 | 80:20 | 10 nm to 1000 nm |
| Comparative | 68.5 | 100 | 9.81 | 36.5 | 65:35 | |
| Example | | | | | | |
| 1 (thoriated | | | | | | |
| tungsten) | | | | | | |
| Comparative | 73 | 10000 | 3.5 | 40.5 | 80:20 | 10 nm to 1000 nm |
| Example | | | | | | |
| 5 | | | | | | |
| Comparative | 73.1 | 2000 | 7.15 | 39.1 | 80:20 | 100 nm to 2000 nm |
| Example | | | | | | |
| 6 | | | | | | |

| | | Flaw | | | |
|---|---|---|---|---|---|
| | | detection | | | |
| | | (number | | 80% Fc | |
| | | of cracks/ | Cumulative | recrystallized | |
| | Recrystallization | 100 | yield | grain | Distribution of channels 210 |
| Number | temperature | meters) | rate(%) | size μm | in carburized layer 200 |
| Example 1 | 50% FC | 0.5-1.0/ | 65% | 5.05 | As shown in FIGS. 15-16, it |
| | | 100 meters | | | includes a first channel 211 and a |
| | | | | | second channel 212. The first |
| | | | | | channel 211 is perpendicular to the |
| | | | | | outer edge 220 of the filament, and |
| | | | | | the second channel 212 intersects |
| | | | | | with the first channel 211 in a |
| | | | | | circular distribution. The carburized |
| | | | | | layer 200 forms a layer block. |
| Comparative | 46% FC | 8.0-12.0/ | 50% | 18.62 | As shown in FIG.17, there are a |
| Example 1 | | 100 meters | | | small number of first channels 211 |
| | | | | | perpendicular to the edge of the |
| | | | | | filament, but the number is relatively |
| | | | | | reduced compared to Example, and |
| | | | | | there are also a small number of |
| | | | | | parallel second channels 212, which |
| | | | | | cannot form a layer block structure. |
| Comparative | 60% FC | 5.0-8.0/ | 56% | 2.12 | Channel 210 is perpendicular to |
| Example 5 | | 100 meters | | | the edge of the filament and points |
| | | | | | towards the center of the filament |
| | | | | | cross-section |
| Comparative | 50% FC | 5-6.0/ | 54% | 6.08 | Same as Example 1 |
| Example 6 | | 100 meters | | | |

| | Electronic | Emission | | | |
|---|---|---|---|---|---|
| | work | performance | Electron | Working | |
| | function | stabilization | emission | temperature, | |
| Number | (Ev) | time(minutes) | performance(mA) | ° C. | working life |
| Example 1 | 2.6 | 30 | 850 | 1150 | >500 h |
| Comparative | 2.64 | 30 | 350 | 1600 | >500 h |
| Example 1 | | | | | |
| Comparative | 2.6 | 20 | 550 | 1150 | <200 h |
| Example 5 | | | | | |
| Comparative | 2.62 | 15 | 500 | 1150 | <100 h |
| Example 6 | | | | | |

TABLE 6
Comparison of the results of Example 1 and
Comparative Example 6

| | Initial | 80% Fc recrystallized |
|---|---|---|
| | recrystallization | grain size |
| Item | temperature Fc % | μm |
| Example 1 | 50% FC | 5.05 |
| Comparative | 60% FC | 2.12 |
| Example 5 | | |

TABLE 7
Comparison of the results of Example 1 and Comparative Example 7

| | | | The average | | |
|---|---|---|---|---|---|
| | Distribution | | size of oxide | | |
| | range of | The average size | particles with a | | |
| | 17 mm billet | of 17 mm billet | cross-sectional | Flaw detection | |
| | oxide | oxide particles, | area of 0.5 mm | (number of cracks/ | Processing |
| Item | particles | nm | wire, nm | 100 meters) | yield, % |
| Example 1 | 100-2000 | 800 | 200 | 0.5-1.0/100 meters | 65% |
| Comparative | 400-5000 | 1400 | 600 | 5.0-6.0/100 meters | 54% |
| Example 6 | | | | | |

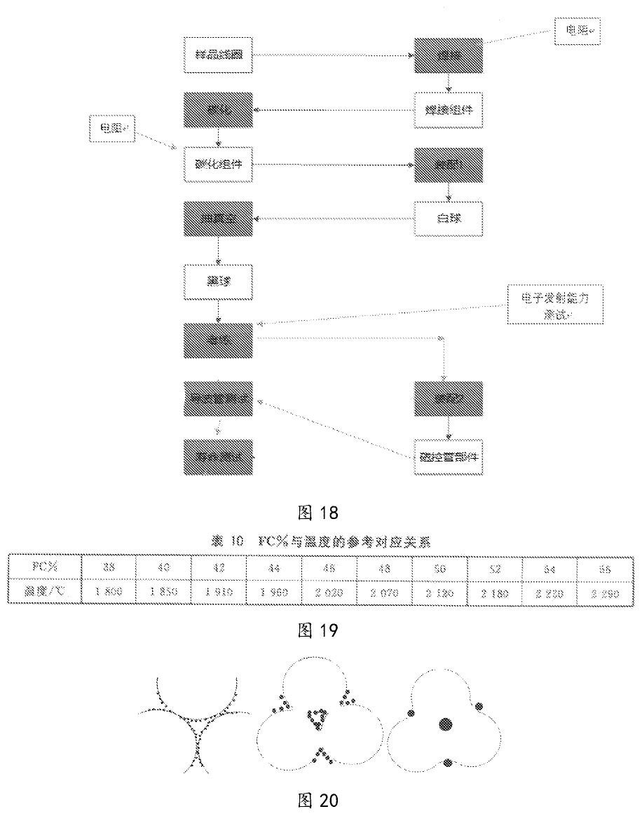

In Table 2-7, the test standard for the recrystallization temperature range item is GB T 23272-2009 Tungsten Wire for Lighting and Electronic Equipment; FC represents the size of the fuse current, and the conversion method of FC % and Celsius is as follows: the high temperature performance test method in Article 4.3.2.2 of the national standard GB/T23272-2009 Tungsten Wire for Lighting and Electronic Equipment as shown in FIG. 19 provides a reference correspondence between FC % and temperature, which can be converted by referring to the correspondence; the electron work function is determined according to the Richardson linear method; the working life of the tungsten alloy filament is tested according to the life test method in Article 6.5.2 of the national standard GB/T 23152-2008 Heating Device for Household Microwave Ovens, wherein the standard requires continuous operation of heating devices for microwave ovens to be >500 h; wherein, the preparation process of steps 10-14 in the embodiment and the test nodes for each test item are shown in FIG. 18.

### 1. Comparison of Example 1 with Comparative Example 1, Comparative Example 1 is a Thoriated Tungsten Filament, and the Initial Recrystallization Temperature of Comparative Example 1 is Lower than the Range Defined in the Present Application

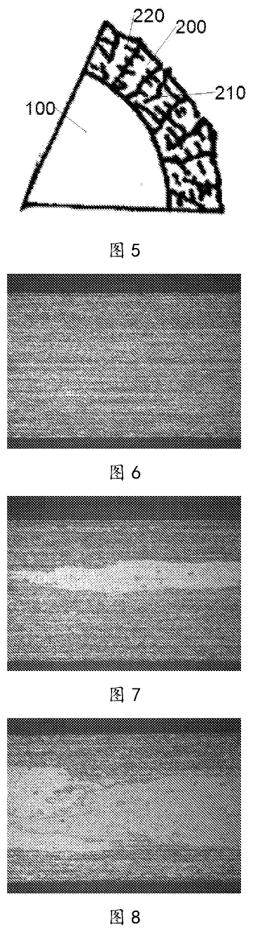

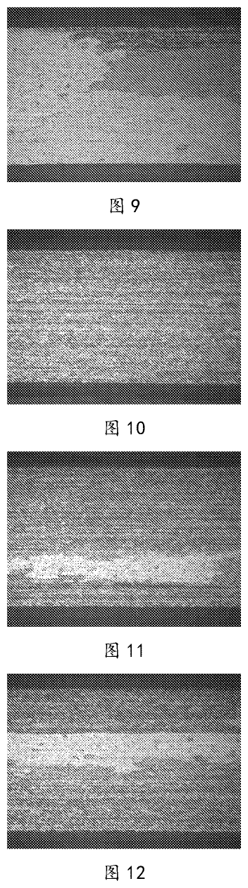

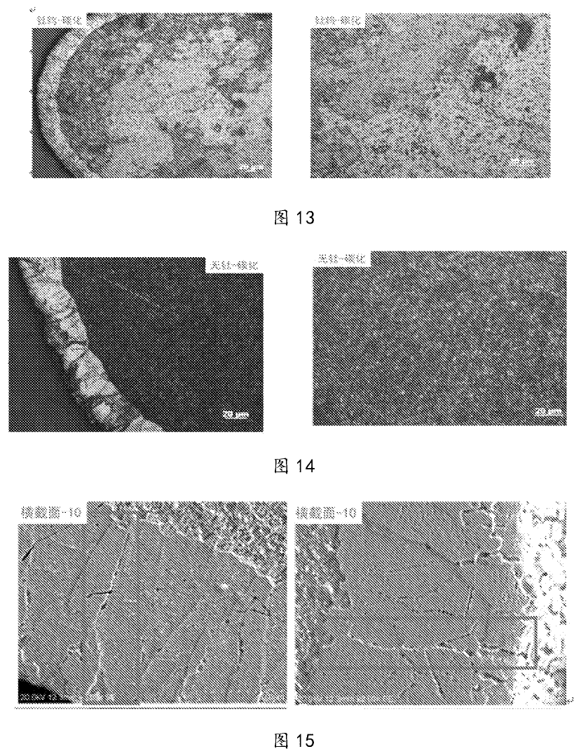

The metallographic conditions of Example 1 and Comparative Example 1 at different fusing currents are shown in FIGS. 6-12: It can be clearly seen that the recrystallization temperature of Example 1 is 50% FC (about 2120° C.), and the recrystallization temperature of Comparative Example 1 is 46% FC (about 2020° C.), which shows that the initial recrystallization temperature of the filament material of the present invention is higher than that of the original thoriated tungsten wire material;
1.1. The effect of the initial recrystallization temperature on the grain width of the carburized layer 200

The grain size of the carbonized filament in Example 1 and Comparative Example 1 is shown in FIGS. 13-14: FIG. 14 shows that the carbonized filament structure in Example 1 is still a fine-grained structure, and FIG. 13 shows that the grains of the carbonized filament structure in Comparative Example 1 are significantly larger. From the data, the number of grains of the tungsten base body 100 after carburization of the base body 100 of Example 1 is 4000/mm², and that of Comparative Example 1 is 100/mm², and the grain width of the carburized layer 200 of Example 1 is 6.83 μm, and that of Comparative Example 1 is 9.81 μm.
1.2. The initial recrystallization temperature affects the grain width of the tungsten alloy filament, thereby affecting the channel distribution of the carburized layer 200, thereby affecting the emission performance:

The distribution of channels 210 of the carbonized filament in Example 1 and Comparative Example 1 is shown in FIGS. 15-17. In the carbonized layer 200 of the cross section of the carbonized filament in Example 1 shown in FIG. 15, there are many first channels 211 distributed perpendicular to the edge of the filament, and the second channels 212 cross the first channels to be distributed in a ring-like shape, and the carbonized layer 200 forms a layer block. In the longitudinal section of the carbonized filament in Example 1 shown in FIG. 16, there are many first channels 211 distributed perpendicular to the edge of the filament; while in the cross section of the carbonized filament in Comparative Example 1 shown in FIG. 17, the number of first channels 211 distributed perpendicular to the edge of the filament is significantly reduced, and there are very few parallel second channels 212. The reason for this is that the grain width of the carbonized layer in Comparative Example 1 is larger, and the number of its channels 210 is related to the size of the grains, and the grain size affects the formation of the channels 210.

In Example 1 of the present invention, the layered structure in the carbonized layer 200 separated by the second channel 212 is where the oxide of M is distributed, the first channel 211 is vertically distributed with the edge of the filament, connecting the inside of the base body 100, the second channel 212 and the edge of the filament, and the second channel 212 is combined with the first channel 211, which is beneficial to the outward migration of rare earth atoms and timely replenishment of rare earth elements evaporated from the surface, thereby improving the stability of material emission.
1.3. The initial recrystallization temperature affects the grain width of the tungsten carbide alloy filament, thus affecting the wire breakage rate, and so on:

The recrystallization temperature of the thoriated tungsten filament is relatively low. After the filament is carburized, the recrystallized grains of the tungsten base body of the filament will be coarse, and the filament will be brittle, resulting in poor anti-seismic performance of the magnetron, and the filament is more likely to break, which in turn causes the magnetron to fail to work. Among them, it can be clearly seen from the data of Comparative Example 1 that the breakage rate and working performance of the thoriated tungsten filament are significantly worse than those of Example 1.

Similarly, when the recrystallization temperature of the tungsten alloy wire of the present application is lower than the specified range of the present application (48% Fc to 56% Fc), the grains of the recrystallized structure of the tungsten base body of the filament will be coarser after the filament is carburized, and the filament will be brittle, resulting in poor seismic performance of the magnetron, the filament will be more likely to break, and the breakage rate will be worse than that of the example.

### 2. Comparison of Example 2 and Comparative Example 2, Example 4 and Comparative Example 3

2.1 The difference between Example 2 and Comparative Example 2 is that: Comparative Example 2 does not add carbide raw materials, and there is no carbon in its components; By comparing the results of the two, it can be seen that: compared with Example 2, the recrystallization temperature of Comparative Example 2 is lower, the grain width of the carburized layer is larger, and the carburized layer 200 has a block structure, which is reflected in the performance: its emission performance stability deteriorates, the electron emission performance deteriorates, and the working life is shortened.
2.2 The difference between Example 4 and Comparative Example 3 is that: Comparative Example 3 does not add carbide raw materials, and there is no carbon in its components; By comparing the results of the two, it can be seen that: compared with Example 4, the recrystallization temperature of Comparative Example 3 is lower, the grain width of the carburized layer is larger, and the carburized layer 200 has a block structure, which is reflected in the performance: its emission performance stability deteriorates, the electron emission performance deteriorates, and the working life is shortened.

The mechanism is analyzed as follows: in the embodiment of the present invention, by adding one or more oxides and carbides of M or carbon simple substance, the oxides and carbides of M in the tungsten base body will react at high temperature, and the generated M metal atoms are much smaller than the particles of M oxides. The migration and diffusion speed of M metal atoms in the tungsten base body will increase. Therefore, compared with the thoriated tungsten filament, it can achieve the same or even higher electron emission capability at a lower operating voltage (excitation temperature). Comparative Examples 2-3 do not add carbon raw materials, and obviously cannot achieve the above effect, and their electron emission performance deteriorates.

### 4. Comparison of Example 7 and Comparative Example 4

The difference between Example 7 and Comparative Example 4 is that the Re content of Comparative Example 4 exceeds the specified range of the present application; by comparing the results of the two, it can be seen that the working temperature of Comparative Example 4 becomes higher and the working life becomes shorter. The inventor analyzed that rhenium has the functions of purifying grain boundaries and strengthening the solid solution of rhenium and tungsten. However, the addition of rhenium content exceeds the specified range of the present application, the rhenium content is too high, the strengthening effect is too large, and the work hardening is too large, which makes the wire more prone to cracks. It can be clearly seen in the wire flaw detection data that the number of flaw detection cracks in Example 7 is 0.8-1.5/100 meters, while that in Comparative Example 5 is 6-10/100 meters.

### 5. Comparison of Example 1 and Comparative Examples 5-6

5.1. Compared with Example 1, the initial recrystallization temperature of Comparative Example 5 is higher than the range specified in the present application: Compared with Example 1, Comparative Example 5 does not use oxidation annealing to control the initial recrystallization temperature of the tungsten alloy wire within a certain range. The initial recrystallization temperature of Comparative Example 5 becomes higher (higher than the range specified in the present application), the number of cracks per 100 meters increases, and the yield rate decreases. It can be seen that for the initial recrystallization temperature, it is not that increasing it blindly will lead to better results. If it is higher than the range specified in the present application, it will also bring adverse effects.
5.2. Comparing Example 1 and Comparative Example 6, the average size of the oxide particles in Comparative Example 6 exceeds the range specified in the present application: Compared with Example 1, the average size of the oxide particles in the billet in Comparative Example 6 becomes larger, and the average size of the oxide particles in the 0.5 mm wire cross section becomes larger. The size of the oxide particles will affect the processing performance, that is, the processing yield and the level of flaw detection. Therefore, the number of crack points per 100 meters of the wire produced in this comparative example increases, and the yield decreases.

### IN SUMMARY, IT CAN BE CLEARLY CONCLUDED FROM THE TEST RESULTS OF THE EXAMPLES AND COMPARATIVE EXAMPLES THAT

1. There is a carbonization process in the preparation of the filament. The carbonization temperature is 2000° C. to 2200° C. The original thoriated tungsten filament is carbonized at this temperature, and the grain structure will show recrystallization. The grains are coarse, which makes the filament very easy to break after carbonization. If the vibration in the production process is slightly larger, the wire will break (the wire breaking rate is about 20,000 ppm to 30,000 ppm).

The recrystallization temperatures measured in Examples 1-7 are between 48% FC (about 2070° C.) and 52% FC (about 2180° C.), and the recrystallization temperature of Comparative Example 1 is 46% FC (about 2020° C.). The initial recrystallization temperature of the filament material produced by the present invention is higher than that of the original thoriated tungsten filament, and the carbonized filament structure is still a fine-grained structure (the grain size of the examples of the present invention is significantly smaller than that of the comparative example), and the filament with a fine-grained structure is not easy to break;
2. Through the observation of the cross-sectional structure, longitudinal section structure and the carburized layer 200 of the longitudinal planed section structure, the recrystallization temperature of the tungsten alloy wire of the present invention is controlled within a certain range, and its initial recrystallization temperature is higher than that of the original thoriated tungsten wire, and the filament structure after carburization is still a fine-grained structure;

Compared with the thoriated tungsten filament, the grain size of the carburized layer 200 of the thoriated tungsten lanthanum filament in the present invention is smaller than that of the thoriated tungsten filament, and the grain width is slightly narrower than that of the thoriated tungsten, so that the number of channels 210 in the carburized layer 200 of the present invention is more, and the organization of the carburized layer 200 at different positions in the filament provided by the present invention has an organization similar to the cross shape of the first channel 211 and the second channel 212, forming a layer block structure. The first channel 211 is vertically distributed with the edge of the filament, connecting the second channel 212, the inside of the base body 100 and the edge of the filament, which is conducive to the outward migration of rare earth atoms and timely replenishment of the rare earth element evaporated from the surface, and improving the stability of the material emission. It can be clearly seen from the emission performance stabilization time data in the test results that there are differences in the emission performance of the filaments. Among them, the emission performance of the filament of the present invention is stable, which is equivalent to that of the traditional thoriated tungsten filament. It can be seen that the tungsten carbide alloy material of the present invention replenishes the rare earth element evaporated from the surface through the stable outward migration of rare earth, thereby improving the stability of the material emission. Without adding thorium element, it can also achieve the stable emission capability of the traditional thorium tungsten filament, solve the problem of poor stable emission capability of the existing thorium-free tungsten filament, and does not have the radioactive pollution problem of the traditional thorium tungsten filament.
3. It can be clearly seen from the test results that the processing performance of the filament material of the present invention is better than that of the original thoriated tungsten, the number of flaw detection cracks is less (when the filament wire diameter can reach 500 μm, the number of flaw detection cracks of the filament is less than 2/100 meters), the processing yield is high, the wound filament is not easy to break, the production efficiency is improved, and the wire material has fewer cracks, and the proportion of broken wires during carbonization of the manufactured filament is also less.
4. It can be clearly seen from the electron emission performance parameters in the test results that the DC emission capacity of the heating device made of the filament of the present invention is nearly twice that of the thoriated tungsten filament (Comparative Example 1), so that the heating device made of the filament provided by the present invention can excite electrons at a lower voltage (Note: According to the use of heating devices in this field, the starting voltage of the thoriated tungsten heating device must be at least 2.0V. In order to ensure the starting voltage, the working voltage is set at 3.3V, while the starting voltage of Example 1 is 1.4V, and the working voltage can be in the range of 1.6 to 1.8V).

The operating temperature of the heating device of the present invention can be reduced from 1500-1600° C. to 1100-1500° C., such as 1200-1300° C., while the operating temperature of the traditional thoriated tungsten filament is 1600-1900° C. Therefore, the energy consumption and life of the heating device provided by the present invention are improved.

### IN SUMMARY, THE ABOVE TECHNICAL SOLUTION PROVIDED BY THE PRESENT INVENTION AT LEAST INCLUDES THE FOLLOWING WORKING PRINCIPLES OR MECHANISMS AND BENEFICIAL EFFECTS

(1) The present invention dopes the tungsten base body powder with oxides and carbides of M and controls the initial recrystallization temperature of the material so that extremely fine grains can still be obtained at the same carburization temperature as that of thoriated tungsten. This can improve the processing performance of the material, reduce the wire breakage rate during the production and use of the material, and reduce the electronic work function of the material. This can not only reduce the wire breakage rate and increase the yield rate to reduce production and transportation costs, but also effectively increase the service life of the filament, making its service life reach and far exceed the service life of the existing thoriated tungsten filament.
(2) The initial recrystallization temperature of the filament material provided by the present invention is between 48% FC (about 2070° C.) and 56% FC (about 2290° C.). Therefore, after carburization at a temperature of 2000° C. to 2100° C., the grains of the tungsten base body 100 are relatively fine, and the brittleness of the carburized filament is less than that of the traditional thoriated tungsten filament material, which can reduce the wire breakage rate of customers during production and use.
(3) Analysis of the influence of the average size of oxide particles: By controlling the average size of the oxide particles of the tungsten alloy wire within the specified range of the present application, it is beneficial to further improve the processing yield and flaw detection level of the wire.
(4) The processing performance of the filament material of the present invention is better than that of the original thoriated tungsten, with fewer flaw detection crack points (when the filament wire diameter can reach 500 μm, the number of flaw detection crack points of the filament is less than 2/100 meters), the processing yield rate is high, the wound filament is not easy to break, the production efficiency is improved, and the wire has fewer crack points, and the proportion of carbonized broken wires in the manufactured filament is also low.
(5) In the filament material provided by the present invention, the oxide of M (such as lanthanum oxide particles) has good plasticity. As the pressure processing proceeds, the oxide particles of M will become thin and long, and exist in a linear or quasi-linear shape; while the thorium oxide in the traditional thoriated tungsten material has poor plasticity. When the thoriated tungsten is processed to a certain extent, the thorium oxide will break. As the processing proceeds, the thorium oxide will appear as a string of particles; the types of rare earth oxides added by the present invention and the changes in morphology and structure during the refinement process make the filament material have good processing performance. When preparing the wire material for winding the filament, the wire diameter of the filament material can be refined to 500 μm or less, and the number of flaw detection crack points is effectively reduced, thereby improving the yield rate.
(6) The operating temperature of the heating device made of the tungsten alloy filament provided by the present invention (i.e., the operating temperature of the filament) can be reduced from 1500-1600° C. to 1100-1500° C., such as within the range of 1200-1300° C., and still maintain a good working condition; while the operating temperature of the traditional thoriated tungsten filament is 1600-1900° C. Therefore, the energy consumption and life of the filament provided by the present invention and the heating device made thereof will be improved.

In summary:

The filament provided by the present invention adds one or more oxides of M and carbides or carbon simple substance into the tungsten base body 100. The combination of the oxides and carbides or carbon simple substance can increase the diffusion rate of the material in the base body 100. Compared with the thoriated tungsten filament, the filament can achieve the same or even higher electron emission capability at a lower operating voltage (excitation temperature).

The present invention dopes oxides and carbides of M into tungsten base body powder and controls the initial recrystallization temperature of the material so that extremely fine grains can still be obtained at the same carburization temperature as that of thoriated tungsten. The present invention can improve the processing performance of the material, reduce the wire breakage rate during the production and use of the material, and reduce the electronic work function of the material. The present invention can reduce the wire breakage rate and improve the yield rate to reduce the production and transportation costs, and can effectively increase the service life of the filament to make the service life reach and far exceed the service life of the existing thoriated tungsten filament.

The filament provided by the present invention can obtain an extremely high recrystallization temperature, and can still obtain extremely fine grains at the same carburization temperature as thoriated tungsten. The material has excellent shock resistance and can reduce the breakage and failure of the filament during production, transportation and use.

It should be noted that:

In this article, “to” is used to indicate a numerical range, and the range indicated by this expression includes two endpoint values;

In summary, the specific parameters or some common reagents or raw materials in the above embodiments are specific embodiments or preferred embodiments of the present invention, but are not intended to limit the present invention; those skilled in the art can make adaptive adjustments within the scope of the present invention. In addition, unless otherwise specified, the raw materials used may also be conventional commercial products in the art, or may be prepared by conventional methods in the art.

In addition, those skilled in the art should understand that, although there are many problems in the prior art, each embodiment or technical solution of the present invention can be improved in only one or several aspects, without having to solve all the technical problems listed in the prior art or background technology at the same time. Those skilled in the art should understand that the content not mentioned in a claim should not be used as a limitation on the claim.

Although the terms such as the initial recrystallization temperature, the average size of oxides, and so on are used more frequently in this article, the possibility of using other terms is not excluded. The use of these terms is only for more convenient description and explanation of the essence of the present invention; interpreting them as any additional limitation is contrary to the spirit of the present invention.

1. A method for preparing tungsten alloy wire, wherein
the tungsten alloy comprises the following components: 0.0005 wt % to 0.3 wt % of a carbon element, 0.25 wt % to 2.6 wt % of an M element, 0.05 wt % to 0.5 wt % of an oxygen element, the balance being a tungsten element and inevitable impurities, and does not comprise a thorium element;
the M element is selected from the group consisting of La, Y, Sc, Nd, Sm, Lu, Ce, Gd, Tb, Dy, Ho, Pr, Er, Tm, Yb, Eu, Hf, and Zr, or a combination of any two or more thereof;
a preparation process of the tungsten alloy wire comprises a doping for powder production step, a powder pressing step, a sintering step, and a pressure processing step in sequence;
in the pressure processing step, the tungsten alloy sintered billet obtained after sintering is refined into an intermediate specification wire with a diameter of 1.5 mm to 3.5 mm; then the intermediate specification wire is subjected to an oxidation annealing at 1200° C. to 1500° C., and the annealing speed is 3 m/min to 10 m/min; after oxidation annealing, the intermediate specification wire is further processed to the required wire diameter specification, so as to obtain tungsten alloy wire;
wherein the initial recrystallization temperature of the tungsten alloy wire is in a range from 48% Fc to 56% Fc, and/or the average size of 80% Fc recrystallized grains is in a range from 1 μm to 15 μm.

2. The method for preparing tungsten alloy wire according to claim 1, wherein the sintering step adopts a high-temperature sintering method to obtain a tungsten alloy sintered billet;
the heating curve of the high-temperature sintering is as follows:
heating from room temperature to A1 at a certain rate, and keeping warm at A1 for a certain period of time;
heating from A1 to A2, with the heating time H3; keeping warm at A2 for H4 hours; wherein A1 is 950° C. to 1250° C., H3 is 1.5 hour to 2.5 hours, A2 is 1300° C. to 1500° C., and H4 is 2.5 hours to 4.5 hours;
heating from A2 to A3 at a certain rate, wherein A3 is 1700° C. to 1900° C.; keeping warm at A3 for a certain period of time;
heating from A3 to A4 at a certain rate, wherein A4 is 2050° C. to 2250° C.; keeping warm at A4 for a certain period of time; and
the tungsten alloy sintered billet is obtained by natural cooling from A4.

3. The method for preparing tungsten alloy wire according to claim 2, wherein the heating curve of the high-temperature sintering is as follows:
heating from room temperature to A1, with the heating time H1 ranging from 5 hours to 8 hours, and A1 ranging from 950° C. to 1250° C.;
keeping warm at A1 for H2 hours, with H2 ranging from 1 hour to 3 hours;
heating from A1 to A2, with the heating time H3 ranging from 1.5 hours to 2.5 hours, and A2 ranging from 1300° C. to 1500° C.;
keeping warm at A2 for H4 hours, with H4 ranging from 2.5 hours to 4.5 hours;
heating from A2 to A3, with the heating time H5 ranging from 1 hour to 3 hours, and A3 ranging from 1700° C. to 1900° C.;
keeping warm at A3 for H6 hours, with H6 ranging from 1 hour to 3 hours;
heating from A3 to A4, with the heating time H7 ranging from 1 hour to 3 hours, and A4 ranging from 2050° C. to 2250° C.;
keeping warm at A4 for H8 hours, with H8 ranging from 5 hours to 10 hours; and
cooling naturally from A4 to obtain the tungsten alloy sintered billet.

4. The method for preparing tungsten alloy wire according to claim 1, wherein the M element is in the form of an oxide, and the average size of the oxide particles in the tungsten alloy wire is in a range from 100 nm to 500 nm.

5. A tungsten alloy wire, wherein the tungsten alloy wire comprises the following components: 0.0005 wt % to 0.3 wt % of a carbon element, 0.25 wt % to 2.6 wt % of am M element, 0.05 wt % to 0.5 wt % of an oxygen element, the balance being a tungsten element and inevitable impurities, and does not contain a thorium element;
wherein the M element is selected from the group consisting of La, Y, Sc, Nd, Sm, Lu, Ce, Gd, Tb, Dy, Ho, Pr, Er, Tm, Yb, Eu, Hf, and Zr, or a combination of any two or more thereof;
the initial recrystallization temperature of the tungsten alloy wire is in a range from 48% Fc to 56% Fc, and/or the average size of the 80% Fc recrystallized grains is in a range from 1 μm to 15 μm.

6. The tungsten alloy wire according to claim 5, wherein the M element is in the form of oxide, and the average size of the oxide particles in the tungsten alloy wire is in a range from 100 nm to 500 nm.

7. The tungsten alloy wire according to claim 5, wherein the M element is in the form of an oxide, and the carbon element is in the form of a carbide or a carbon simple substance;
the oxide of M is selected from the group consisting of lanthanum oxide, yttrium oxide, scandium oxide, neodymium oxide, samarium oxide, lutetium oxide, cerium oxide, gadolinium oxide, terbium oxide, dysprosium oxide, holmium oxide, praseodymium oxide, erbium oxide, hafnium oxide, and zirconium oxide, or a combination of any two or more thereof;
the carbide is selected from the group consisting of lanthanum carbide, zirconium carbide, yttrium carbide, hafnium carbide and tungsten carbide, or a combination of any two or more thereof.

8. The tungsten alloy wire according to claim 5, wherein the tungsten alloy wire has a wire diameter of 800 μm or less, and a number of crack points detected by flaw detection less than 5/100 meters;
and/or, the component of the tungsten alloy wire further comprises T element; the T element is a metal element, and the T is selected from at least one of K, Re, Mo, Fe, and Co; wherein the mass content of the Re is less than 1000 ppm.

9. Use of tungsten alloy wire, wherein: after the tungsten alloy filament is carbonized and used as a cathode alloy wire for a microwave heating device;
wherein the tungsten alloy wire is prepared by the preparation method according to claim 1.

10. A carbonized tungsten alloy filament, wherein the carbonized tungsten alloy filament is obtained by carbonizing tungsten alloy wire;
wherein the tungsten alloy wire is prepared by the preparation method according to claim 1.

11. The tungsten alloy wire according to claim 6, wherein the M element is in the form of an oxide, and the carbon element is in the form of a carbide or a carbon simple substance;
the oxide of M is selected from the group consisting of lanthanum oxide, yttrium oxide, scandium oxide, neodymium oxide, samarium oxide, lutetium oxide, cerium oxide, gadolinium oxide, terbium oxide, dysprosium oxide, holmium oxide, praseodymium oxide, erbium oxide, hafnium oxide, and zirconium oxide, or a combination of any two or more thereof;
the carbide is selected from the group consisting of lanthanum carbide, zirconium carbide, yttrium carbide, hafnium carbide and tungsten carbide, or a combination of any two or more thereof.

12. Use of tungsten alloy wire, wherein: after the tungsten alloy filament is carbonized and used as a cathode alloy wire for a microwave heating device;
wherein the tungsten alloy wire is the tungsten alloy wire according to claim 5.

13. A carbonized tungsten alloy filament, wherein the carbonized tungsten alloy filament is obtained by carbonizing tungsten alloy wire;
wherein the tungsten alloy wire is the tungsten alloy filament according to claim 5.
